(19) United States
(12) Patent Application Publication
(10) Pub. No.: US 2025/0199467 A1
(43) Pub. Date: Jun. 19, 2025

(54) PROCESS CARTRIDGE

(71) Applicant: JIANGXI YIBO E-TECH CO. LTD., Xinyu (CN)

(72) Inventors: Shiping AO, Xinyu (CN); Xiaomin GONG, Xinyu (CN); Rongli XU, Xinyu (CN)

(21) Appl. No.: 19/063,458

(22) Filed: Feb. 26, 2025

Related U.S. Application Data
(63) Continuation of application No. PCT/CN2023/115115, filed on Aug. 26, 2023.

(30) Foreign Application Priority Data
Aug. 27, 2022 (CN) 202222264165.2
Sep. 3, 2022 (CN) 202222339632.3
Sep. 7, 2022 (CN) 202222378286.X
Sep. 9, 2022 (CN) 202222400643.8
Dec. 16, 2022 (CN) 202223379747.1
Feb. 17, 2023 (CN) 202320243918.3
Mar. 25, 2023 (CN) 202320609481.0
May 13, 2023 (CN) 202321147311.1

(51) Int. Cl. G03G 21/18

(52) U.S. Cl. CPC G03G 21/186

(57) ABSTRACT

Disclosed in the present disclosure is a process cartridge, comprising: a frame; a photosensitive drum; a first coupling member is capable of receiving an external force and driving the photosensitive drum to rotate; the first coupling member comprises a first protruding portion, and the first protruding portion comprises: a first surface extending in a direction away from the photosensitive drum in a first direction; a second surface located on a downstream side of the first surface in a rotation direction of the first coupling member, the second surface extending in a direction away from the photosensitive drum and arranged obliquely relative to the first direction; a third surface, wherein a distance from the first end of the photosensitive drum to the third surface when measured in the first direction decreases along the extension of the third surface in the rotation direction of the first coupling member; wherein in the rotation direction of the first coupling member, a starting position of the extension of the third surface is flush with the first surface or located on the downstream side of the first surface.

### TECHNICAL FIELD

The present disclosure relates to the technical field of electrophotographic imaging, and in particular to a process cartridge.

### BACKGROUND

The present disclosure provides a process cartridge, which is detachably mounted in an image forming device, wherein the image forming device includes a driving unit, and the driving unit includes a driving force applying member and a braking force applying member. The process cartridge includes a photosensitive drum and a coupling member arranged at one end of the length direction of the photosensitive drum. The coupling member has a driving force receiving portion and a braking force receiving portion. The driving force receiving portion may be coupled with the driving force applying member to drive the photosensitive drum to rotate. The braking force receiving portion may be engaged with the braking force applying member to receive a braking force, and the braking force is used to resist the load of the rotation of the coupling member. That is, the coupling member can simultaneously receive a driving force and a braking force from the driving unit, which can increase the torque required for the photosensitive drum to rotate. Therefore, the speed fluctuation of the photosensitive drum is suppressed, and the rotation of the photosensitive drum is more stable, However, the structure of the coupling member for receiving the driving force and the braking force in the process cartridge of the prior art is relatively complicated, which leads to an increase in the manufacturing cost of the process cartridge.

### SUMMARY

In order to solve the above problem, the present disclosure provides a new process cartridge, which is mainly achieved through the following technical solutions:

A process cartridge, comprising:
a frame; a photosensitive drum rotatably supported on the frame and being rotatable about a photosensitive drum rotation axis extending in a first direction; a first coupling member connected to a first end of the photosensitive drum in the first direction, wherein the first coupling member is capable of receiving an external force and driving the photosensitive drum to rotate; the first coupling member comprises a first protruding portion, and the first protruding portion comprises: a first surface extending in a direction away from the photosensitive drum in a first direction; a second surface located on a downstream side of the first surface in a rotation direction of the first coupling member, the second surface extending in a direction away from the photosensitive drum and arranged obliquely relative to the first direction; and a third surface, wherein a distance from the first end of the photosensitive drum to the third surface when measured in the first direction decreases along the extension of the third surface in the rotation direction of the first coupling member; wherein in the rotation direction of the first coupling member, a starting position of the extension of the third surface is flush with the first surface or located on the downstream side of the first surface.

Preferably, wherein an ending position of the extension of the third surface is adjacent to the second surface in the rotation direction of the first coupling member.

Preferably, wherein the first coupling member further comprises a second protruding portion; the second protruding portion comprises a protruding portion surface extending in the rotation direction of the first coupling member and facing away from the photosensitive drum in the first direction; and in the rotation direction of the first coupling member, the protruding portion surface is arranged on an upstream side of the third surface and spaced apart from the third surface.

Preferably, wherein a downstream end of the protruding portion surface in the rotation direction of the first coupling member has a first distance point; when measured in a direction perpendicular to the first direction, the first distance point is the farthest point on the protruding portion surface from the rotation axis of the first coupling member; and after projection in the first direction, a first line segment connecting the first distance point and a point located at an upstream end of the third surface in the rotation direction of the first coupling member is made, and the shortest length of the first line segment is K, where 0 mm<K<4 mm.

Preferably, wherein in the first direction, a downstream end of the protruding portion surface in the rotation direction of the first coupling member is flush with an upstream end of the third surface in the rotation direction of the first coupling member, or is further away from the photosensitive drum than the upstream end of the third surface in the rotation direction of the first coupling member.

Preferably, wherein the protruding portion surface comprises a fourth surface and a fifth surface arranged adjacent to each other; the fourth surface is arranged on an upstream side of the fifth surface in the rotation direction of the first coupling member; a distance from the first end of the photosensitive drum to the fourth surface when measured in the first direction increases along the extension of the fourth surface in the rotation direction of the first coupling member; and the fifth surface is configured as a plane perpendicular to the first direction.

Preferably, wherein the first coupling member further comprises a shield surface extending about the rotation axis of the first coupling member, the shield surface and the fourth surface have an overlapping portion when projected along the first direction, and the shield surface is flush with the fifth surface in the first direction.

Preferably, wherein the first coupling member further comprises a second protruding portion located on an upstream side of the first protruding portion in the rotation direction of the first coupling member; the second protruding portion comprises a protruding portion surface extending in the rotation direction of the first coupling member and facing away from the photosensitive drum in the first direction; and the first coupling member further comprises a groove formed on the second protruding portion, and the groove is arranged at a position closer to the photosensitive drum than the protruding portion surface in the first direction.

Preferably, wherein the first coupling member further comprises a fourth surface arranged on the downstream side of the second surface in the rotation direction of the first coupling member; a distance from the first end of the photosensitive drum to the fourth surface when measured in the first direction increases along the extension of the fourth surface in the rotation direction of the first coupling member; and a second line segment perpendicular to the first direction and connecting the third surface and the fourth surface is made, and the shortest distance of the second line segment is M, where 1 mm<M<4 mm.

Preferably, wherein 2 mm<M<3 mm.

Preferably, wherein an upstream end of the third surface in the rotation direction of the first coupling member has a first point; a downstream end of the third surface in the rotation direction of the first coupling member has a second point; when measured in a direction perpendicular to the first direction, the first point and the second point are both points on the third surface that are farthest from the rotation axis of the first coupling member; and a third line segment connecting the first point and the second point is made, and a length of the third line segment is W, where 3 mm<W<4 mm.

In the process cartridge provided by the present disclosure, on the premise of ensuring that the first coupling member is stably engaged with the driving force applying member and the braking force applying member of the image forming device, in a first aspect, by reducing the inclined surface structure in the first coupling member, the structure of the first coupling member is simplified and the yield rate is improved; in a second aspect, by providing the groove structure on the second protrusion of the first coupling member, the material usage is reduced and the production cost is reduced; in a third aspect, the first coupling member adopts a retractable structure, which can improve the coupling stability of the first coupling member and the driving unit; in a fourth aspect, by providing an abutment surface, the braking force applying member can be pushed to retract, so that the first coupling member can work normally without receiving the braking force of the image forming device, which can effectively remove the redundant design of the image forming device and simplify the structure of the image forming device.

### BRIEF DESCRIPTION OF FIGURES

FIG. 1 is a schematic view of a process cartridge in Embodiment 1 of the present disclosure before being mounted in a tray;

FIG. 2 is a schematic view of the process cartridge in Embodiment 1 of the present disclosure when being mounted in the tray;

FIG. 3 is a schematic view of the process cartridge and the tray in Embodiment 1 of the present disclosure when being mounted in the image forming device;

FIG. 4 is a schematic view of a first driving unit force bearing member in Embodiment 1 of the present disclosure when being located in a first position;

FIG. 5 is a schematic view of the first driving unit force bearing member in Embodiment 1 of the present disclosure when being located in a second position;

FIG. 6 is a schematic view of a driving force applying member and a braking force applying member in Embodiment 1 of the present disclosure when they are separated from each other;

FIG. 7 is an exploded schematic view of a first driving unit in Embodiment 1 of the present disclosure;

FIG. 8 is a schematic view of a positional relationship between the process cartridge and the image forming device in Embodiment 1 of the present disclosure when a door cover is in an open position;

FIG. 9 is a schematic view of a positional relationship between the process cartridge and the image forming device in Embodiment 1 of the present disclosure when the door cover is in a closed position;

FIG. 10 is a partial enlarged schematic view of a cooperation relationship between the image forming device and the process cartridge in Embodiment 1 of the present disclosure;

FIG. 11 is a schematic view of the process cartridge in Embodiment 1 of the present disclosure when viewed from an angle;

FIG. 12 is a schematic view of the process cartridge in Embodiment 1 of the present disclosure when viewed from another angle;

FIG. 13 is a schematic view of the process cartridge in Embodiment 1 of the present disclosure when viewed from further another angle;

FIG. 14 is a schematic view of a developing unit and a drum unit in Embodiment 1 of the present disclosure when they are separated from each other;

FIG. 15 is a schematic view of the drum unit in Embodiment 1 of the present disclosure;

FIG. 16 is an exploded schematic view of the drum unit in Embodiment 1 of the present disclosure;

FIG. 17 is a schematic view of a first coupling member in Embodiment 1 of the present disclosure when viewed from an angle;

FIG. 18 is a schematic view of the first coupling member in Embodiment 1 of the present disclosure when viewed from another angle;

FIG. 19 is a schematic view of the first coupling member and a braking force receiving member in Embodiment 1 of the present disclosure before they are in contact with each other;

FIG. 20 is a schematic view of the first coupling member and the braking force receiving member in Embodiment 1 of the present disclosure when they are in contact with each other;

FIG. 21 is a schematic view of a force bearing claw and a first coupling member in Embodiment 2 of the present disclosure before they are in contact with each other;

FIG. 22 is a schematic view of the force bearing claw and a first guide portion in Embodiment 2 of the present disclosure when they are in contact with each other;

FIG. 23 is a schematic view of the force bearing claw and a second inclined surface in Embodiment 2 of the present disclosure when they are in contact with each other;

FIG. 24 is a schematic view of a force bearing claw and a first coupling member in Embodiment 3 of the present disclosure before they are in contact with each other;

FIG. 25 is a schematic view of the force bearing claw and a first guide portion in Embodiment 3 of the present disclosure when they are in contact with each other;

FIG. 26 is a schematic view of the force bearing claw and an abutment surface in Embodiment 3 of the present disclosure when they abut against each other;

FIG. 27 is a schematic view of a first coupling member in Embodiment 4 of the present disclosure when viewed from an angle;

FIG. 28 is a schematic view of the first coupling member and a first driving unit in Embodiment 4 of the present disclosure before they are coupled;

FIG. 29 is a schematic view of the first coupling member in Embodiment 4 of the present disclosure when viewed from another angle;

FIG. 30 is a schematic view of a first coupling member in Embodiment 5 of the present disclosure when viewed from an angle;

FIG. 31 is a schematic view of the first coupling member in Embodiment 5 of the present disclosure when viewed from another angle;

FIG. 32 is a schematic view of the first coupling member in Embodiment 5 of the present disclosure when viewed from further another angle;

FIG. 33 is a schematic view of the first coupling member in Embodiment 5 of the present disclosure when viewed from still another angle;

FIG. 34 is a schematic view of the first coupling member in Embodiment 5 of the present disclosure;

FIG. 35 is a schematic side view of the first coupling member in Embodiment 5 of the present disclosure;

FIG. 36 is a schematic view of the cooperation between the first coupling member and a force bearing member in Embodiment 5 of the present disclosure;

FIG. 37 is a schematic view of another implementation structure of the first coupling member in Embodiment 5 of the present disclosure;

FIG. 38 is a schematic view of a first coupling member in Embodiment 6 of the present disclosure when viewed from an angle;

FIG. 39 is a schematic view of the first coupling member in Embodiment 6 of the present disclosure when viewed from another angle;

FIG. 40 is a schematic view of a first coupling member in Embodiment 7 of the present disclosure;

FIG. 41 is a schematic view of a first coupling member in Embodiment 8 of the present disclosure;

FIG. 42 is an exploded schematic view of the first coupling member in Embodiment 8 of the present disclosure;

FIG. 43 is a schematic cross-sectional view of the first coupling member in Embodiment 8 of the present disclosure;

FIG. 44 is a schematic cross-sectional view of the first coupling member in Embodiment 8 of the present disclosure when being in a retracted position;

FIG. 45 is a schematic cross-sectional view of the first coupling member in Embodiment 8 of the present disclosure when being in an extended position;

FIG. 46 is a schematic cross-sectional view of the first coupling member in Embodiment 8 of the present disclosure when being in the retracted position and before pushing a driving force applying member;

FIG. 47 is a schematic cross-sectional view of the first coupling member in Embodiment 8 of the present disclosure when being in the extended position and pushing the driving force applying member;

FIG. 48 is a schematic view, when viewed from an angle, of a process cartridge in Embodiment 9 of the present disclosure when a first coupling member is in a retracted position;

FIG. 49 is a schematic view, when viewed from an angle, of the process cartridge in Embodiment 9 of the present disclosure when the first coupling member is in an extended position;

FIG. 50 is a schematic view of the developing cartridge in Embodiment 9 of the present disclosure when the first coupling member is in the retracted position after a protective cover is disassembled from the process cartridge;

FIG. 51 is a schematic view of the process cartridge in Embodiment 9 of the present disclosure when the first coupling member is in the extended position after the protective cover is disassembled from the process cartridge;

FIG. 52 is an exploded schematic view of a right end of the developing cartridge in Embodiment 9 of the present disclosure;

FIG. 53 is a schematic view, when viewed from another angle, of the developing cartridge in Embodiment 9 of the present disclosure when the first coupling member is in the retracted position;

FIG. 54 is a schematic view, when viewed from another angle, of the developing cartridge in Embodiment 9 of the present disclosure when the first coupling member is in the extended position;

FIG. 55 is a schematic view of the process cartridge in Embodiment 9 of the present disclosure when the first coupling member is in the retracted position after the protective cover is removed from the process cartridge;

FIG. 56 is a schematic view of the process cartridge in Embodiment 9 of the present disclosure when the first coupling member is in the extended position after the protective cover is removed from the process cartridge;

FIG. 57 is a schematic view of a coupling member in Embodiment 9 of the present disclosure;

FIG. 58 is a schematic view of the coupling member in Embodiment 9 of the present disclosure when being in a retracted position and an extended position;

FIG. 59 is a schematic view of a process cartridge in Embodiment 10 of the present disclosure when viewed from an angle;

FIG. 60 is a schematic view of the process cartridge in Embodiment 10 of the present disclosure when viewed from another angle;

FIG. 61 is a schematic view of the process cartridge in Embodiment 10 of the present disclosure when viewed from further another angle;

FIG. 62 is an exploded schematic view of a driving side of the process cartridge in Embodiment 10 of the present disclosure;

FIG. 63 is an exploded schematic view of a first urging member and a second urging member in Embodiment 10 of the present disclosure;

FIG. 64 is a schematic view of a coupling member in Embodiment 10 of the present disclosure;

FIG. 65 is a schematic view of the process cartridge in Embodiment 10 of the present disclosure when the coupling member is in a retracted position;

FIG. 66 is a schematic view of the process cartridge in Embodiment 10 of the present disclosure when the coupling member is in an extended position;

FIG. 67 is a schematic view of the process cartridge in Embodiment 10 of the present disclosure when the coupling member is in the retracted position after a protective cover is removed from the process cartridge;

FIG. 68 is a schematic view of the process cartridge in Embodiment 10 of the present disclosure when the coupling member is in the extended position after the protective cover is removed from the process cartridge;

FIG. 69 is a schematic view of the cooperation between the first urged member and the second urged member in Embodiment 10 of the present disclosure when the coupling member is in the retracted position;

FIG. 70 is a schematic view of the cooperation between the first urged member and the second urged member in Embodiment 10 of the present disclosure when the coupling member is in the extended position;

FIG. 71 is a schematic view of the coupling member in Embodiment 10 of the present disclosure when being in the retracted position and the extended position;

FIG. 72 is a schematic view of the cooperation between a second protrusion of a connecting shaft of an image forming device and a third protrusion of a driving force applying member in Embodiment 10 of the present disclosure;

FIG. 73 is a schematic view of a positional relationship between the process cartridge and a pressing member in Embodiment 10 of the present disclosure before the process cartridge is mounted in the image forming apparatus 1;

FIG. 74 is a partial enlarged schematic view of the positional relationship between the process cartridge and the pressing member in Embodiment 10 of the present disclosure before the process cartridge is mounted in the image forming apparatus 1;

FIG. 75 is a schematic view of the positional relationship between the process cartridge and the pressing member in Embodiment 10 of the present disclosure after the process cartridge is mounted in the image forming apparatus 1;

FIG. 76 is a partial enlarged schematic view of the positional relationship between the process cartridge and the pressing member in Embodiment 10 of the present disclosure after the process cartridge is mounted in the image forming apparatus 1;

FIG. 77 is a schematic view of the process cartridge in Embodiment 10 of the present disclosure when viewed from further another angle;

FIG. 78 is an exploded schematic view of the process cartridge in Embodiment 10 of the present disclosure after a protective cover is disassembled from the process cartridge;

FIG. 79 is a partial exploded schematic view of a right side of the process cartridge in Embodiment 10 of the present disclosure;

FIG. 80 is a schematic view of a positional relationship between an urging member and a control portion of the process cartridge in Embodiment 10 of the present disclosure;

FIG. 81 is a schematic cross-sectional view of a right side of the process cartridge in Embodiment 10 of the present disclosure;

FIG. 82 is a schematic view of a partial anti-detachment structure of a process cartridge in Embodiment 11 of the present disclosure;

FIG. 83 is an exploded schematic view of the anti-detachment structure in Embodiment 11 of the present disclosure;

FIG. 84 is a schematic view of a positional relationship between the anti-detachment structure and a driving force applying member in Embodiment 11 of the present disclosure before an urging member urges an urged member;

FIG. 85 is a schematic view of the anti-detachment structure in Embodiment 11 of the present disclosure before the urging member urges the urged member; and

FIG. 86 is a schematic view of the anti-detachment structure in Embodiment 11 of the present disclosure when the urging member urges the urged member.

### DETAILED DESCRIPTION

### Embodiment 1

To better describe and understand a process cartridge 100 in Embodiment 1 of the present disclosure, various directions of the process cartridge 100 are defined in Embodiment 1, wherein the length direction of the process cartridge 100 is a left-right direction (first direction), and a first coupling member 110 is arranged at a right end (first end) of the process cartridge 100 in the left-right direction; the process cartridge 100 can be mounted in an image forming device 1 along a direction from rear to front (second direction); and an up-down direction (third direction) is perpendicular to both the front-rear direction and the left-right direction.

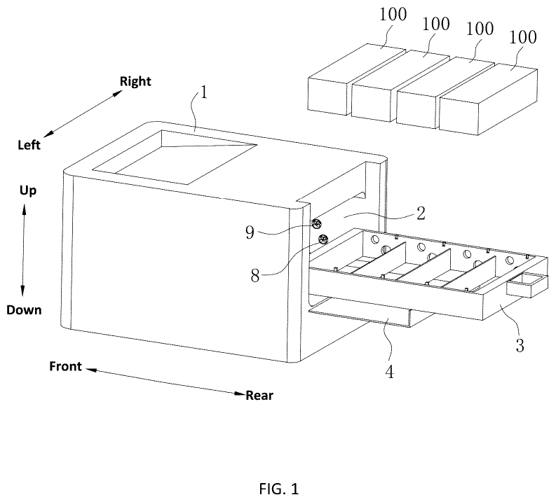

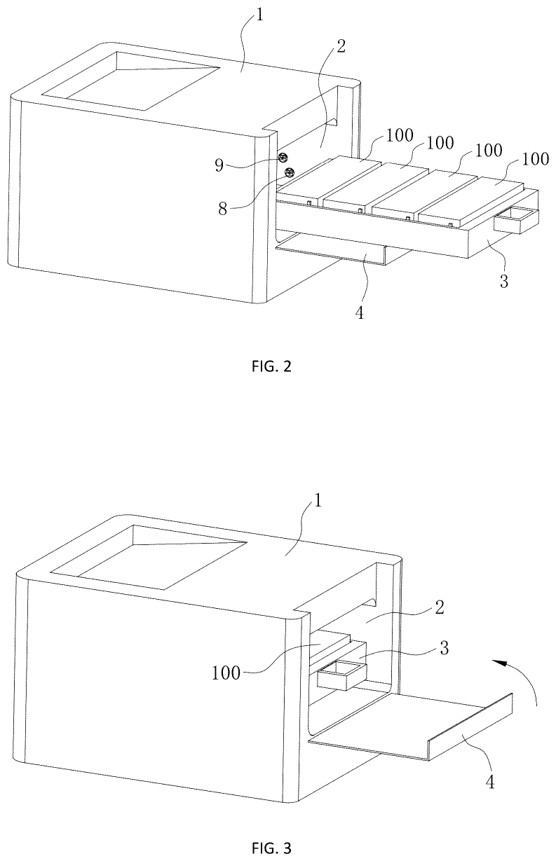

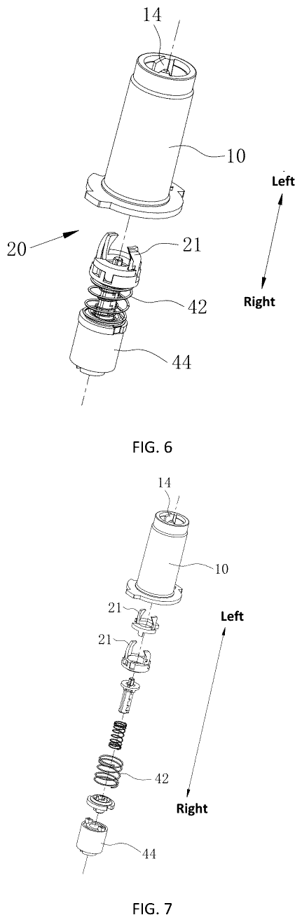

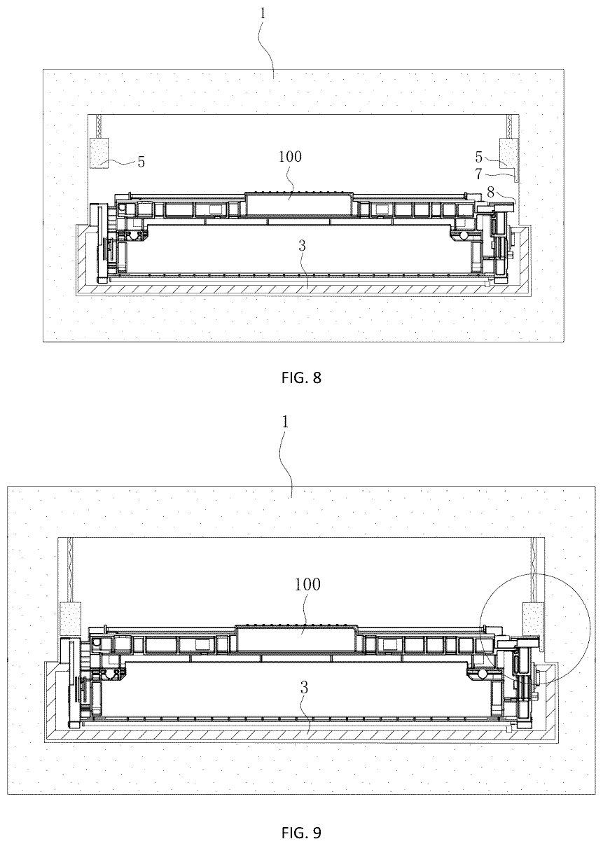

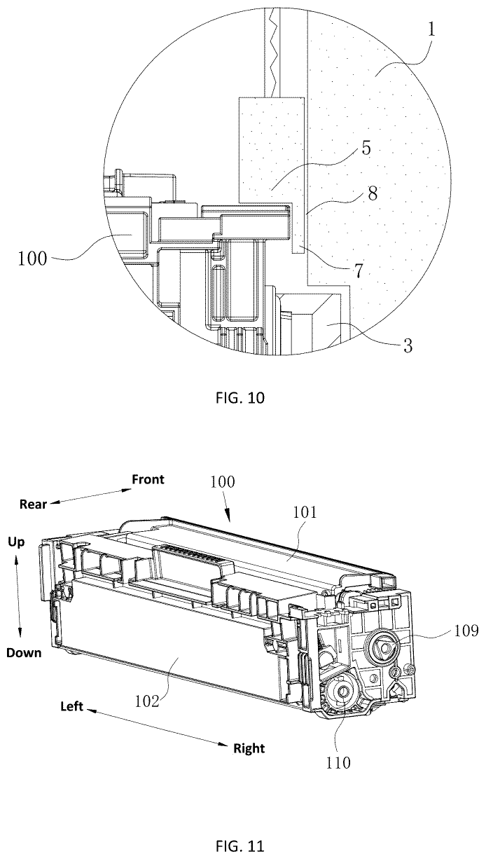

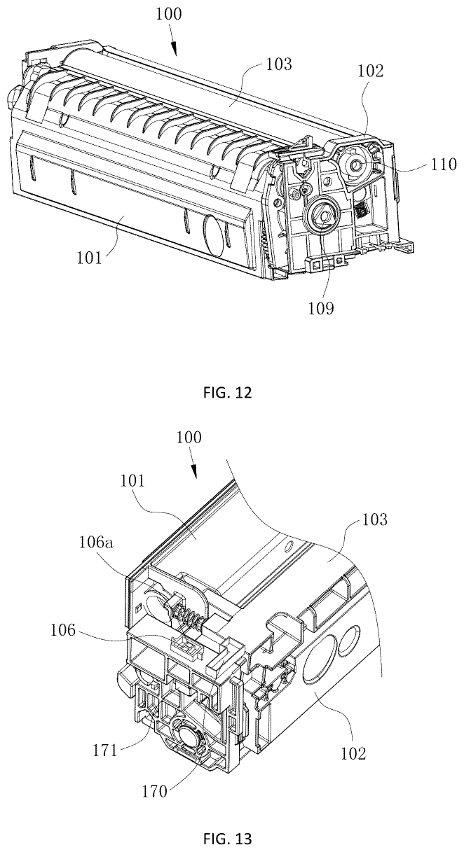

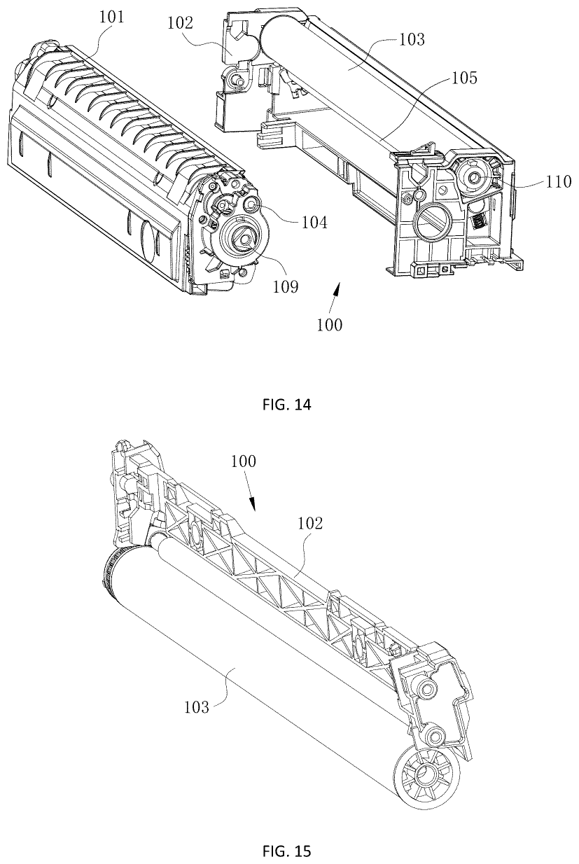

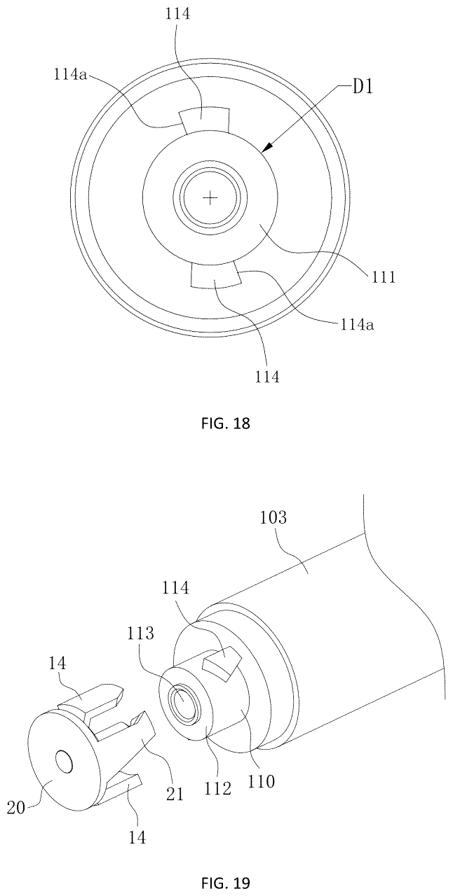

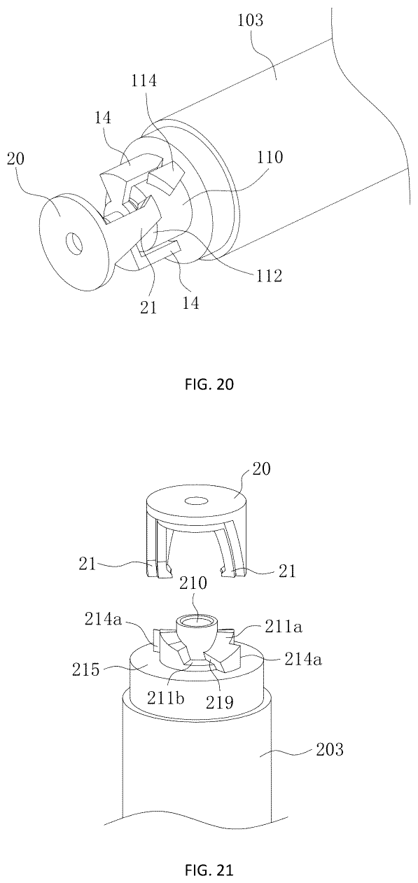

As shown in FIGS. 1-20, an image forming device 1 and a process cartridge 100 in Embodiment 1 of the present disclosure which is detachably mounted in the image forming device 1 are shown. Next, the image forming device 1 and the process cartridge 100 will each be described in detail with reference to specific drawings.

### [Image Forming Device]

As shown in FIGS. 1-10, an image forming device 1 is shown. The image forming device 1 includes a hollow accommodating chamber 2, a tray 3 that may slide along the front-rear direction and be mounted in the accommodating chamber 2, and a door cover 4. The door cover 4 may be rotated between an open position in which the accommodating chamber 2 can be exposed and a closed position in which the accommodating chamber 2 is covered. The tray 3 may support the process cartridge 100 and be mounted in the accommodating chamber 2 of the image forming device 1 along the direction from rear to front. A transfer belt that may transfer an image on the process cartridge 100 to a sheet of paper is further provided at a lower end of the tray 3, and the transfer belt may move upward and downward according to the opening/closing operation of the door cover 4. When the process cartridge 100 is mounted in the tray 3, the transfer belt and a photosensitive drum 103 may come into and out of contact with each other according to the opening/closing operation of the door cover 4.

The image forming device 1 further includes a first driving unit 8 and a second driving unit 9 which are rotatable and are arranged on a right end wall of the accommodating chamber 2. The first driving unit 8 may be used to drive the photosensitive drum 103 (specifically described in detail later) of the process cartridge 100 to rotate, and the second driving unit 9 may be used to drive the developing roller 104 (specifically described in detail later) of the process cartridge 100 to rotate. The first driving unit 8 and the second driving unit 9 are each connected with an elastic member, and the first driving unit 8 and the second driving unit 9 may retract and extend according to the opening/closing operation of the door cover 4 to avoid interference with the process cartridge 100. The first driving unit 8 includes a driving force applying member 10 and a braking force applying member 20. The braking force applying member 20 is arranged inside the driving force applying member 10, and the two may rotate around the same axis.

The driving force applying member 10 may be driven to rotate by a driving assembly in the image forming device 1. An elastic member is connected to a right end portion of the driving force applying member 10. The driving force applying member 10 includes a pair of driving protrusions 14 arranged at an interval of 180 degrees. The driving protrusion 14 includes a driving surface 14a facing a downstream side of the driving force applying member 10 in a rotation direction thereof. The driving surface 14a may be used as a driving part to couple with a first coupling member 110 (to be described below) of the process cartridge 100 to drive the first coupling member 110 to rotate.

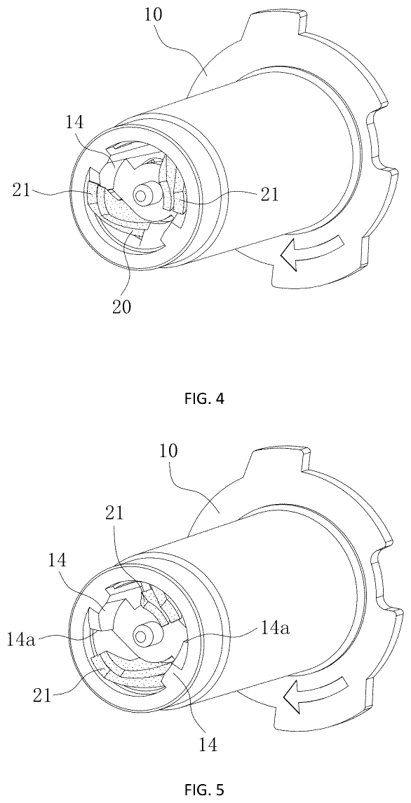

The braking force applying member 20 includes a force bearing member. The force bearing member may be rotated between a first position close to one of the driving protrusions 14 in FIG. 4 and a second position away from the one of the driving protrusions 14 in FIG. 5 in the rotation direction of the driving force applying member 10 relative to the driving force applying member 10. The force bearing member includes a first force bearing member 20a and a second force bearing member 20b that are mounted together and may rotate together. The first force bearing member 20a and the second force bearing member 20b are each provided with a force bearing claw 21 which is exposed to the outside of the first driving unit 8 and may receive an external rotational force to rotate together. The force bearing claw 21 is operably connected to a damper 44, and the damper 44 is configured to be rotatable with the force bearing claw 21. The damper 44 driven to rotate may generate damping and may transmit the damping to the force bearing claw 21 of the force bearing member. In addition, the braking force applying member 20 further includes a spring 42. The spring 42 may apply its compressed and accumulated elastic force to the force bearing member, so that the force bearing claw 21 of the force bearing member is kept in an extended position.

Pressing members 5 are further provided on an upper left side and an upper right side of the accommodating chamber 2 of the image forming device 1, respectively. The pressing members 5 may move upward or downward according to the opening/closing operation of the door cover 4, and may press the process cartridge 100. In addition, the image forming device 1 further includes a positioning member 7 arranged adjacent to the pressing member 5 at the right end. The positioning member 7 may also move upward or downward when the door cover 4 is opened/closed. When the door cover 4 is closed, the positioning member 7 may move downward and be inserted into a position in a gap portion 8 formed by the process cartridge 100 and the right side wall of the accommodating chamber 2, so that the process cartridge 100 can be stably positioned in the image forming device 1 in the left-right direction.

### [Process Cartridge]

Next, the process cartridge 100 in Embodiment 1 of the present disclosure will be described in detail. As described above, the process cartridge 100 is detachably mounted in the image forming device 1 in the prior art. Specifically, as shown in FIGS. 1-20, the process cartridge 100 includes a developing unit and a drum unit connected to each other, wherein the developing unit includes a developing frame 101 capable of accommodating developer, a developing roller 104 supported on the developing frame 101 and capable of carrying the developer, and a supply roller (not shown). The developing unit is further provided with a first electrode 171. The first electrode 171 has a first electrode contact surface that may be electrically connected to a power supply component of the image forming device 1. The first electrode contact surface is arranged on a left end portion of the developing unit, is in elastic contact with the power supply component, and is configured to urge the first electrode 171 from left to right, which also makes the process cartridge 100 urged toward the right side. Therefore, the first coupling member 110 and the second coupling member 109 of the process cartridge 100 maintain a stable coupling with the image forming device, and the possibility that the first coupling member 110 and the second coupling member 109 are decoupled from the first driving unit 8 and the second driving unit 9 may be avoided to a certain extent. Preferably, the first electrode 171 is arranged at the left end portion of the developing unit, and the first electrode 171 may transmit the power to the developing roller 104 and the supply roller and supply power to them. That is, the first electrode 171 is electrically connected to the developing roller 104 and the supply roller. A second coupling member 109 is further provided at the right end of the developing unit, and the second coupling member 109 may be coupled with the second driving unit 9 of the image forming device 1 and receive a driving force outputted therefrom, thereby driving the developing roller 104 and the supply roller to rotate.

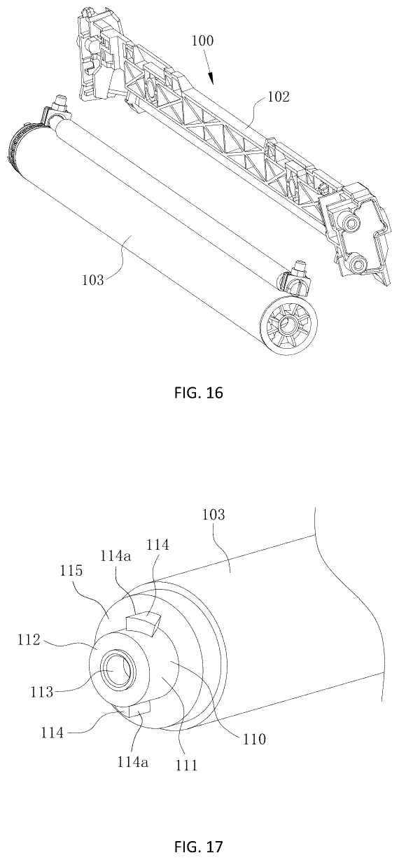

The drum unit includes a drum frame 102, a photosensitive drum 103 supported on the drum frame 102 and capable of forming an electrostatic latent image, and a charging roller 105 in contact with the photosensitive drum 103 and capable of charging the photosensitive drum 103. As shown in FIGS. 15-16, there is no accommodating chamber for accommodating waste developer in the drum frame 102. After the photosensitive drum 103 completes the development and imaging, the developer that does not participate in the development and imaging may be recovered to the image forming device by the transfer belt of the image forming device. Therefore, this helps to reduce the volume of the process cartridge 100 and facilitates the miniaturization of the developing cartridge.

The process cartridge 100 is further provided with a second electrode 170. The second electrode 170 has a second electrode contact surface, which is arranged at the upper left end portion of the process cartridge 100. Preferably, the second electrode 170 is arranged at the upper left end portion of the drum frame 102 of the process cartridge 100 and faces the upper end of the process cartridge 100. The second electrode 170 is configured to be electrically connected to the power supply component at the upper end of the image forming device 1, and can supply the power to the charging roller 105. That is, the second electrode 170 may be electrically connected to the charging roller 105. When the process cartridge 100 is mounted in the image forming device 1 and the door cover 4 is closed, the power supply component is in elastic contact with the second electrode 170 and is configured to apply pressure downward to the second electrode 170. That is, the elastic force may urge the process cartridge 100 to the tray 3 from top to bottom, so that the process cartridge 100 is further stably positioned on the tray 3, thereby reducing the jitter of the process cartridge 100, the first driving unit 8 and the second driving unit 9 during the coupling process, and improving coupling stability. In addition, the process cartridge 100 further includes a chip 106. The chip 106 has a chip contact surface 106a arranged at the upper left end portion of the process cartridge 100, which is spaced apart from the first electrode contact surface of the first electrode 171 in the front-rear direction and is arranged at a position closer to the front end of the process cartridge 100 relative to the first electrode. The chip contact surface 106a may be electrically connected to the image forming device 1, so that the chip 106 may establish a communication connection with the image forming device 1, and the information of the process cartridge 100 stored in the chip 106, such as the model, developer capacity, etc., can thus be read by the image forming device 1. The image forming device 1 maintains an elastic contact with the chip contact surface 106 of the chip 106 and is configured to apply pressure downward to the chip contact surface 106a of the chip 106. That is, the elastic force may urge the process cartridge 100 to the tray 3 from top to bottom, so that the process cartridge 100 is further stably positioned on the tray 3, thereby reducing the jitter of the process cartridge 100, the first driving unit 8 and the second driving unit 9 during the coupling process, and improving the coupling stability. Moreover, in the process cartridge 100, the first electrode contact surface of the first electrode 171, the second electrode contact surface of the second electrode 170 and the chip contact surface of the chip 106 are all arranged on the left side of the process cartridge 100, that is, they are arranged on a different side from the first coupling member 110 and the second coupling member 109 of the process cartridge 100 in the length direction of the process cartridge 100, so that the first electrode contact surface of the first electrode 171, the second electrode contact surface of the second electrode 170 and the chip contact surface of the chip 106 can be as far away from the first coupling member 110 and the second coupling member 109 as possible in the left-right direction. The first coupling member 110 and the second coupling member 109 cause the process cartridge 100 to jitter due to rotation when coupled with the image forming device 1. Since the left side of the process cartridge 100 is farther away from the first coupling member 110 and the second coupling member 109 than the right side thereof, the jitter of the left side of the process cartridge 100 becomes lower than the jitter of the right side thereof. The first electrode contact surface of the first electrode 171, the second electrode contact surface of the second electrode 170 and the chip contact surface of the chip 106 arranged on the left side of the process cartridge 100 will become more stable when they are each electrically connected to the image forming device 1, thereby improving electrical connection stability.

When the process cartridge 100 performs imaging work, the developer carried by the developing roller 104 may be conveyed to the photosensitive drum 103 and can be used to develop the electrostatic latent image on the photosensitive drum 103. The formed developer image may be transferred to a sheet of paper through the transfer belt in the image forming device 1, thereby completing a cycle of development and imaging work. The first coupling member 110 is connected to the right end portion of the photosensitive drum 103, and the first coupling member 110 may be coupled with the driving force applying member 10 of the first driving unit 8 of the image forming device 1 and can receive a driving force outputted therefrom, so that the photosensitive drum 103 may be driven to rotate. Specifically, the first coupling member 110 includes an end surface 115 and a positioning post 111 protruding outward from the end surface 115. The positioning post 111 may also be referred to as a protruding part. A positioning hole 113 coaxially arranged with the positioning post 111 is formed in the positioning post 111. When the process cartridge 100 is mounted in the image forming device 1, a driving force applying member positioning post 13 of the driving force applying member 10 of the image forming device 1 may be inserted into the positioning hole 113, and the positioning post 111 may be inserted between a pair of driving protrusions 14 of the driving force applying member 10 to be positioned in an inner cavity 16 of the driving force applying member. When the two are positioned together, the positioning of the driving force applying member 10 and the first coupling member 110 in a radial direction is more stable, which improves the relative position accuracy and coupling stability of the two. The first coupling member 110 further includes a pair of driven protrusions 114 (first protruding portions) arranged approximately 180 degrees apart in the circumferential direction of the positioning post 13. The driven protrusion 114 includes a first surface 114a (driven surface) that is substantially parallel to the left-right direction. The first surface 114a is a surface facing the upstream side of the coupling member 110 in the rotation direction. The first surfaces 114a of the pair of driven protrusions 114 may be matched and engaged with the driving surfaces 14a of the pair of driving protrusions 14 of the driving force applying member 10, and can receive the driving force transmitted by the driving force applying member 10, so that the first coupling member 110 can drive the photosensitive drum 103 to rotate. That is, the first coupling member 110 can receive the driving force transmitted by the first driving unit 8 to rotate through the coupling of the driven protrusions 114 with the driving protrusions 14 of the driving force applying member 10.

Further, a blocking portion 112 is provided on the right end portion of the positioning post 111. In this embodiment, the blocking portion 112 is configured as a portion on the right end portion of the positioning post 111. The blocking portion 112 may also be referred to as a blocking surface or an abutment surface. When the process cartridge 100 is mounted on the tray 3 and the two are mounted in the image forming device 1, the first driving unit 8 will extend and gradually move in the left-right direction toward the direction close to the first coupling member 110 when the door cover 4 is moved from the open position to the closed position. As the first driving unit 8 further extends, the force bearing claw 21 at the left end of the braking force applying member 20 will come into contact with the blocking portion 112, and a reaction force generated urges the force bearing claw 21 to retract to avoid the blocking portion 112. In other words, the blocking portion 112 is configured to be capable of urging the force bearing claw 21 to retract when the door cover 4 is closed, so as to provide sufficient space to avoid the blocking portion 112. At this time, the first coupling member 10 is not coupled with the braking force receiving member 20, and when the retraction distance is sufficient, the force bearing claw 21 will be disconnected from the damper 44, so that even if the force bearing claw 21 is driven to rotate, it cannot output damping, and the first coupling member 110 cannot receive the braking force of the braking force receiving member 20. Further, to achieve the above-mentioned technical effect, the size of the blocking portion 112 arranged on the positioning post 111 should have a suitable size. If it is too small, it will not only reduce the strength of the positioning post 111, but also make it impossible to ensure the inner diameter of the positioning hole 113. If it is too large, the blocking portion 112 will cause axial installation interference with the pair of driving protrusions 14 of the driving force applying member 10. Therefore, it is defined here that the blocking portion 112 has a diameter D1 after rotating one circle, where 6 mm≤D1≤12 mm. Within this range, the blocking portion 112 can meet the above requirements. In other words, when measured along a direction perpendicular to the first direction, the distance between at least a part of the blocking portion 112 and a rotation axis of the first coupling member 110 is D1, where 6 mm≤D1≤12 mm, preferably, 8 mm≤D1≤10 mm. Moreover, the positioning post 111 has a height H in the left-right direction, where 0.5 mm≤H≤7 mm. If the positioning post 111 is too high, axial installation interference will occur between the positioning post 111 and the driving force applying member 10. If the positioning post 111 is too short, the force bearing claw 21 will not be able to retract by a sufficient distance, so that the force bearing claw will be connected to the damper 44. Preferably, 0.6 mm≤H≤2.5 mm.

### Embodiment 2

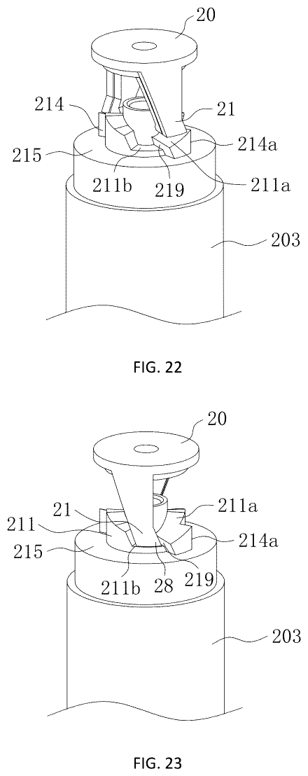

Next, Embodiment 2 of the present disclosure will be described in detail with reference to FIGS. 21-23. Embodiment 2 provides a process cartridge. The same parts as those in the above embodiment will not be described in detail in Embodiment 2. The difference is that the structure of the first coupling member 210 of the process cartridge is different.

Specifically, in addition to the driven protrusions 214 and the first surfaces 214a formed on the driven protrusions 214 which have been described previously, the first coupling member 210 includes third surfaces 211a formed on the driven protrusions 214. The third surface 211a may be used to guide the force-receiving claw 21 of the braking force receiving member to move from right to left in a direction close to the photosensitive drum 203. Preferably, the third surface 211a is configured as a spiral inclined surface, which extends from right to left around the rotation axis of the first coupling member 210. The distance from a first end of the photosensitive drum 203 to the third surface 211a measured in the first direction decreases along the extension of the third surface 211a in the rotation direction of the first coupling member 610. An abutment surface 211b is further provided on the downstream side of the third surface 211a. The abutment surface 211b and the end surface 215 are spaced apart in the left-right direction and are arranged on different planes. When viewed in a direction perpendicular to the first direction, the abutment surface 211b and the second surface 219 have an overlapping part. Specifically, the abutment surface 211b is arranged on the right side of the end surface 215 in the left-right direction, and the height difference between the two in the left-right direction is greater than or equal to 0.5 mm. Preferably, the height difference between the two in the left-right direction is greater than or equal to 0.6 mm and less than or equal to 2.5 mm, so that the force bearing claw 21 is disconnected from the damper 44 after abutting against the abutment surface 211b.

In the left-right direction, a second surface 219 is formed between the third surface 211a and the end surface 215. In other words, in the rotation direction of the first coupling member 210, the second surface 219 is arranged on the downstream side of the first surface 214a. In the first direction, the second surface 219 extends in a direction away from the photosensitive drum 203 and is configured to be arranged crosswise with the first direction. The second surface 219 may be engaged with the force-receiving claw 21 of the braking force receiving member 20, so that the first driving unit 8 and the first coupling member 210 can be prevented from moving to a large extent in the left-right direction or even being decoupled, thereby affecting the coupling stability between the two. Optionally, the second surface 219 may also be configured as a structure substantially parallel to the first direction. The first surface 214a is a surface facing the upstream side of the first coupling member 210 in the rotation direction, and the second surface 219 is a surface facing the downstream side of the first coupling member 210 in the rotation direction. In other words, the first surface 214a and the second surface 219 are surfaces on different sides of the driven protrusion 214 in the rotation direction of the first coupling member 210, that is, the first surface 214a and the second surface 219 are surfaces opposite to each other in the circumferential direction, and in the left-right direction, the left end portion of the second surface 219 (i.e., the engaging part between the second surface 219 and the abutment surface 219) is further away from the photosensitive drum 203 than the left end portion of the first surface 214a (i.e., the engaging part between the first surface 214a and the end surface 215). Therefore, when the process cartridge is mounted in the image forming device 1, as the door cover 4 is closed, the first driving unit 8 will gradually extend out and move toward a position close to the first coupling member 210. When the force bearing claw 21 of the braking force receiving member 20 comes into contact with the third surface 211a, the force bearing claw 21 overcomes the elastic force of the spring 42 to be in a retracted position. Subsequently, the force bearing claw 21 may be guided by the third surface 211a to rotate by a certain angle relative to the driving force applying member 10 and gradually extend out in a direction close to the photosensitive drum 203. As the braking force receiving member 20 further rotates, the third surface 211a may guide the force bearing claw 21 to come into contact with the abutment surface 211b, and then the force bearing claw 21 engages with the second surface 219 of the first coupling member 210. At this time, the two maintain engaged so that the first driving unit 8 and the first coupling member 210 can be prevented from moving left and right during rotation, thereby ensuring the axial engagement amount between the driving surface 14a and the first surface 214a, and improving the coupling stability of the first driving unit 8 and the first coupling member 210. Moreover, at this time, the force bearing claw 21 cannot be fully extended out because it abuts against the abutment surface 211b. Therefore, even if the force bearing claw 21 is driven to rotate due to friction with the first coupling member 210, the retracted force bearing member will be disconnected from the damper 44 and cannot output damping.

### Embodiment 3

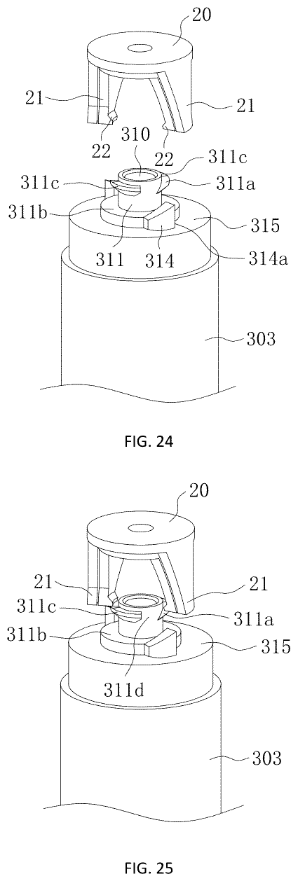

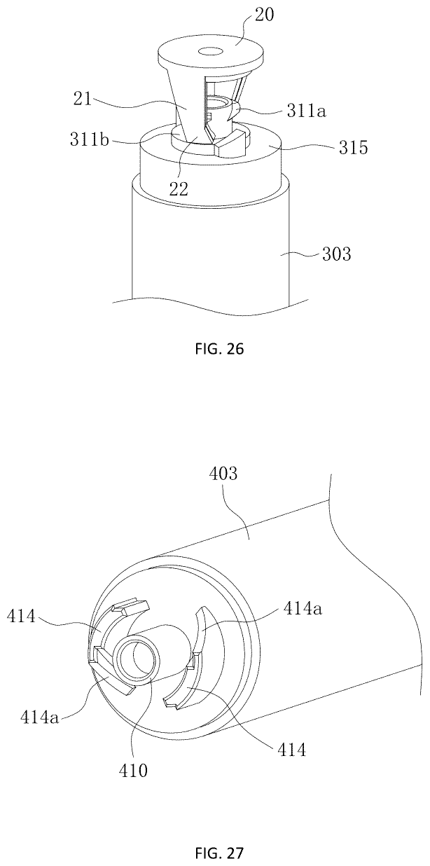

Next, Embodiment 3 of the present disclosure will be described in detail with reference to FIGS. 24-26. Embodiment 3 provides a process cartridge. The same parts as those in the above embodiment will not be described in detail in Embodiment 3. The difference is that the structure of the first coupling member 310 of the process cartridge is different.

Specifically, in addition to the driven protrusions 314 and the first surfaces 314a formed on the driven protrusions 314 which have been described previously, the first coupling member 310 includes a pair of shield parts 311c formed on the right end portion of the positioning post 311. The shield part 311c is configured as a protrusion radially protruding outward along an outer peripheral surface of the positioning post 311, and the pair of shield parts 311c are arranged on the outer peripheral surface of the positioning post 311 at intervals in the circumferential direction. In other words, the pair of shield parts 311c are formed with notches 311d in the circumferential direction, the notches 311d are communicated with the left and right sides of the shield parts 311c, and a third surface 311a is provided on the right side surface of the shield part 311c. The first coupling member 310 further includes an abutment surface 311b arranged on the left side of the shield part 311c, and the abutment surface 311b is spaced apart from the end surface 315 in the left-right direction and is arranged on different planes. Specifically, the abutment surface 311b is arranged on the right side of the end surface 315 in the left-right direction, and the height difference between the two in the left-right direction is greater than or equal to 0.5 mm. Preferably, the height difference between the two in the left-right direction is greater than or equal to 0.6 mm and less than or equal to 2.5 mm, so that the force bearing claw 21 is disconnected from the damper 44 after abutting against the abutment surface 311b. Therefore, when the process cartridge is mounted in the image forming device 1, as the door cover 4 is closed, the first driving unit 8 will gradually extend out and move toward a position close to the first coupling member 310. When the force bearing claw 21 of the braking force receiving member 20 comes into contact with the third surface 311a, the force bearing claw 21 overcomes the elastic force of the elastic member to be in a retracted position. Subsequently, the force bearing claw 21 may be guided by the third surface 311a to rotate by a certain angle relative to the driving force applying member 10 and gradually extend out in a direction close to the photosensitive drum 303. Moreover, as the braking force receiving member 20 further rotates, the third surface 311a may guide the force bearing claw 21 to a position in contact with the abutment surface 311b of the first coupling member 310, and the driving surface 14a of the driving force applying member 10 meshes with the first surface 314a of the first coupling member 310. At this time, the braking force applying member 20 is still in the retracted position and not fully extended out compared with the braking force applying member 20 in a state without external force. Therefore, the force bearing claw 21 in this state is disconnected from the damper 44 and cannot output damping. At the same time, even if the force bearing claw 21 is driven to rotate due to the friction with the first coupling member 310, and after the force bearing claw 21 abuts against the abutment surface 311b, the shield part 311c may block the force bearing claw 21 in the left-right direction so that the force bearing claw 21 can be prevented from moving significantly, thereby ensuring the axial engagement amount between the driving surface 14a and the first surface 314a, and improving the coupling stability of the first driving unit 8 and the first coupling member 310.

### Embodiment 4

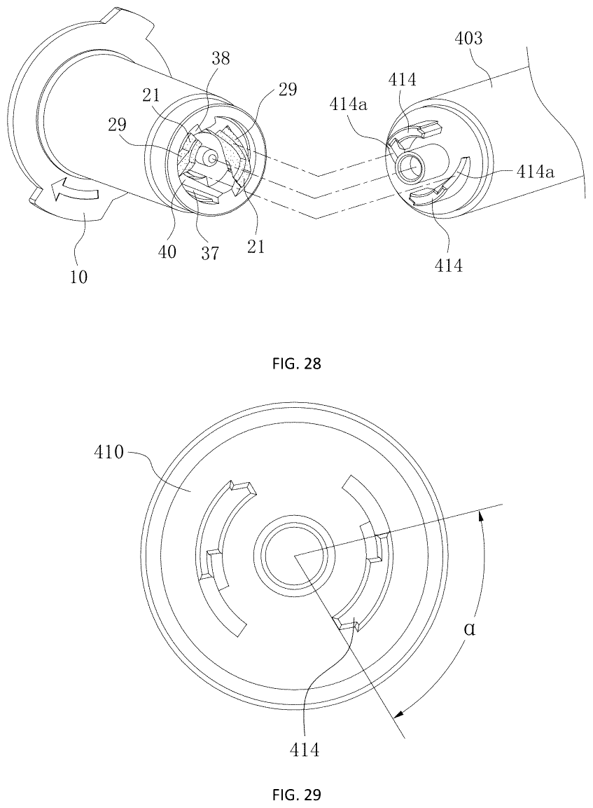

As in FIGS. 27-29, next, Embodiment 4 of the present disclosure will be described in detail. Embodiment 4 shows a process cartridge. The parts of the process cartridge in this embodiment that are the same as those in the above embodiments will not be described in detail here. The difference is that the structure of the first coupling member 410 of the process cartridge is different.

Specifically, the first coupling member 410 in this embodiment also includes a pair of driven protrusions 414 spaced apart and arranged opposite to each other in the rotation direction of the first coupling member 410. However, the first surface 414a on the driven protrusion 414 for being driven is an inclined surface, which is a surface on the driven protrusion 414 facing the upstream side of the first coupling member 410 in the rotation direction. Moreover, the inclined surface is arranged crosswise with the left-right direction and at least a part faces the right end of the first coupling member 410. That is, the first surface 414a is arranged crosswise with the left-right direction and at least a part faces the right end of the first coupling member 410.

Further, in the rotation direction of the first coupling member 410, the width of an extended end (i.e., free end) of the driven protrusion 414 is greater than the width of a second groove 38 formed by an extended end of the force bearing claw 21 and the driving protrusion 14 when the force bearing member is in a second position, but is less than the width of between a pair of driving protrusions 14. In other words, in the rotation direction of the first coupling member 410, with the rotation axis of the first coupling member 410 as a center, the angle at which the driven protrusion 414 extends around the first coupling member is α, where 45°<α<135°, so that during the coupling process of the first coupling member 410 and the first driving unit 8, the driven protrusion 414 can only enter a first groove 37 but not the second groove 38. Specifically, during the coupling process of the first coupling member 410 and the first driving unit 8, one of the situations of the force bearing member is that when the force bearing member is in the first position as shown in FIG. 4, the driven protrusion 414 of the first coupling member 410 may be matched and inserted into the first groove 37 formed by the force bearing claw 21 and the other driving protrusion 14. At this time, the first surface 414a of the driven protrusion 414 comes into contact with a first inclined surface 29 of the force bearing claw 21 (the surface of the force bearing claw 21 facing the downstream side of the first coupling member 410 in the rotation direction), so that the driven protrusion 414 and the driving protrusion 14 maintain engaged. After the driving force applying member 10 is driven by the image forming device 1 to rotate counterclockwise, the first inclined surface 29 of the force bearing claw 21 urges the first surface 414a of the first coupling member 410 to generate a first component of force in the rotation direction of the driving force applying member 10. The first component of force may drive the first coupling member 410 and the photosensitive drum 403 connected thereto to start rotating. That is, the first driving unit 8 may rely on the force bearing claw 21 to drive the first coupling member 410 to rotate, and at the same time, the first inclined surface 29 generates a second component of force in the left-right direction in the process of urging the first surface 414a. Moreover, since the position of the first coupling member 410 in the left-right direction is substantially unchangeable, and the force bearing claw 21 may retract after being subjected to force because a spring is connected to the force bearing member. Therefore, the second component of force reacts on the force bearing claw 21 to overcome the elastic force of the spring to force the force bearing claw 21 to retract by a certain distance, which may also disconnect the force bearing member from the damper 44. At this time, the force bearing claw 21 of the force bearing member does not output damping.

Another situation of the force bearing member is that when the force bearing member is in the second position as shown in FIG. 5, since the width of the extended end (i.e., free end) of the driven protrusion 414 in the rotation direction of the first coupling member 410 is greater than the width of the second groove 38 formed by the force bearing claw 21 and the driving protrusion 14 in the rotation direction of the driving force applying member 10 when the force bearing member is in the second position, and is smaller than the width of between the pair of driving protrusions 14 in the rotation direction of the driving force applying member 10, the driven protrusion 414 will not be able to directly enter the first groove 37 and the second groove 38 at this time, thereby preventing the driven protrusion 414 from being mistakenly inserted into the second groove 38. However, as the driving force applying member 10 rotates, when the driving force applying member 10 rotates to the position where the first groove 37 and the driven protrusion 414 face each other, the inclined surface structure of the first surface 414a of the first coupling member 410 will come into contact with the first inclined surface 29 of the force bearing claw 21 and gradually cut into the first groove 37. Moreover, in the process, the force bearing member is forced to move from the second position to the first position. Finally, the first surface 414a is engaged with the first inclined surface 29, and the force bearing claw 21 drives the first coupling member 410 to start rotating.

In this embodiment, the force bearing claw 21 of the force bearing member is used to drive the first coupling member 410 to rotate, thereby changing the driving surface of the first driving unit 8 for driving the first coupling member 410. Moreover, by using the structure in which the two come into contact through the inclined surface, the force bearing member may be forced to disconnect from the damper 44 during the coupling and rotation process of the first driving unit 8 with the first coupling member 410, so that the force bearing claw 21 cannot output damping, thereby simplifying the structure of the process cartridge.

### Embodiment 5

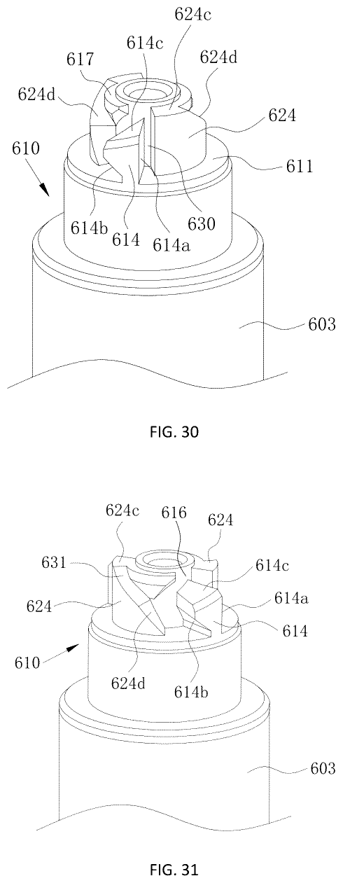

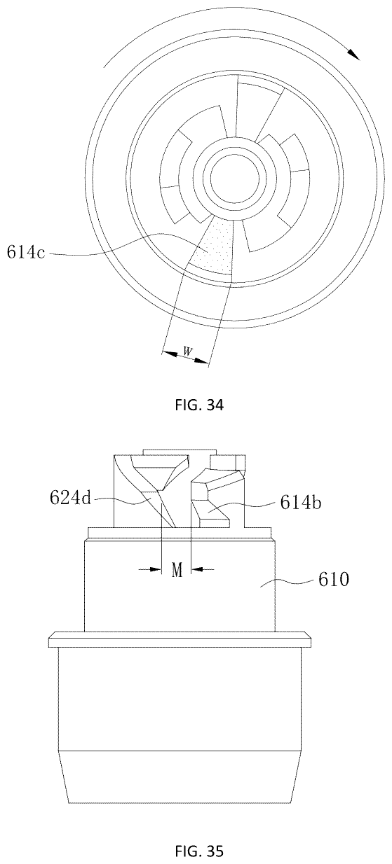

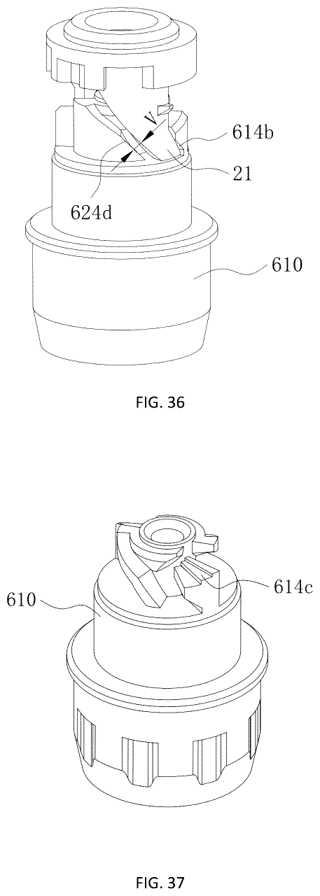

As shown in FIGS. 30-37, a process cartridge in Embodiment 5 of the present disclosure is shown. The process cartridge includes, but is not limited to, the same parts as those in Embodiment 3 above. For example, the first coupling member 610 includes a first protruding portion 614, the first protruding portion 614 includes a first surface 614a extending in a first direction away from the photosensitive drum 603, a second surface 614b located on the downstream side of the first surface 614a in the rotation direction of the first coupling member 610, and a third surface 614c extending from the first surface 614a or from the downstream side of the first surface 614a to the adjacent second surface 614b in the rotation direction of the first coupling member 610 (the third surface 614c may also be configured as a stepped surface as shown in FIG. 37), so that the third surface 614c is as close to the second surface 614b as possible in the rotation direction of the first coupling member 610, thereby providing a longer guiding distance for the force bearing claw 21 and improving the coupling success rate of the first coupling member 610 and the force bearing claw 21. In other words, in the rotation direction of the first coupling member 610, the starting position of the extension of the third surface 614c is flush with the first surface 614a or is located on the downstream side of the first surface 614a, and the first coupling member 610 in this embodiment also includes a shielding part 617. The structures and mutual positional relationships of these components are substantially the same as those in Embodiment 3 above, and will not be described in detail in this embodiment.

The difference is that the first coupling member 610 further includes a second protruding portion 624 protruding from a end surface 611 in a direction away from the photosensitive drum 603, and in the rotation direction of the first coupling member 610, the second protruding portion 624 is spaced apart from the first protruding portion 614. Specifically, the second protruding portion 624 includes a second protruding portion surface 631 extending in the rotation direction of the first coupling member 610 and facing a side away from the photosensitive drum 603 in the first direction. In the rotation direction of the first coupling member 610, the second protruding portion surface 631 is arranged on the upstream side of the third surface 614c and spaced apart from the third surface 614c. That is, along the rotation direction of the first coupling member 610, the downstream side end of the second protruding portion surface 631 maintains a certain spacing distance from the upstream side end of the third surface 614c, and there is a gap 630 between the two. In other words, the second protruding portion surface 631 is not adjacent to the third surface 614c. If in this case (there is a gap 630 between the second protruding portion surface 631 and the third surface 614c), the gap 630 is made smaller, the force bearing claw 21 will not get stuck when it comes into contact with the second protruding portion surface 631 and the third surface 614c in sequence or slides on the two. Then, this structure in this embodiment may also be used as a guide portion which guides the force bearing claw 21 to engage with the second surface 614b. When there are limitations on a mold for producing a coupling member by molding, a coupling member with this structure may also be used. Moreover, compared with the structure in which the second protruding portion surface 631 and the third surface 614c are adjacent to each other, the coupling member with this structure saves more materials and can reduce the material requirement cost to a certain extent.

It can be known from the above description that the gap 630 is arranged between the second protruding portion surface 631 and the third surface 614c. In the rotation direction of the first coupling member 610, there is a certain spacing distance between the downstream end of the second protruding portion surface 631 and the upstream end of the third surface 614c. The downstream end of the second protruding portion surface 631 in the rotation direction of the first coupling member 610 has a first distance point. The first distance point is the farthest point on the second protruding portion surface 631 from the rotation axis of the first coupling member 610 when measured in a direction perpendicular to the first direction. After projection in the first direction, a first line segment connecting the first distance point and the upstream end of the third surface 614c in the rotation direction of the first coupling member 610 is made. The shortest length of the first line segment is K, where 0 mm<K<4 mm. Furthermore, 0.5 mm<K<2 mm, so as to avoid the problems that when K is set small enough, the material requirement of the first coupling member 610 cannot be significantly reduced, and when K is set large enough, the force bearing claw 21 cannot pass over the gap 630 after being separated from a fourth surface 624d, causing the force bearing claw 21 to be stuck in the gap 630.

The second protruding portion surface 631 includes a fourth surface 624d and a fifth surface 624c arranged adjacent to each other. In the rotation direction of the first coupling member 610, the fifth surface 624c is arranged on the downstream side of the fourth surface 624d and located at the downstream end of the second protruding portion surface 631. The distance from the first end of the photosensitive drum 603 to the fourth surface 624d when measured in the first direction increases along the extension of the fourth surface 624d in the rotation direction of the first coupling member 610. The angle between the fourth surface 624d and the end surface 611 is defined as β1, and the angle between the fifth surface 624c and the end surface 611 is defined as β2, where β2<β1, so as to ensure that the force bearing claw 21 provides a greater sliding speed when it is separated from the fourth surface 624d with a larger inclination angle and slides to the fifth surface 624c with a smaller inclination angle, thereby ensuring that the force bearing claw 21 can pass over the gap 630. Further, the fifth surface 624c is configured as a plane perpendicular to the left-right direction, which, on the one hand, can reduce the configuration of inclined surfaces and simplify the structure of the first coupling member 610, and, on the other hand, allows the force bearing claw 21 to provide a greater sliding speed when the force bearing claw 21 is separated from the fifth surface 624c configured as an inclined surface and slides to the fourth surface 624d configured as a plane, thereby further ensuring that the force bearing claw 21 can pass over the gap 630.

In the first direction, the downstream end of the second protruding portion surface 631 in the rotation direction of the first coupling member 610 is flush with the upstream end of the third surface 614c in the rotation direction of the first coupling member 610, or is farther away from the photosensitive drum 603 than the upstream end of the third surface 614c in the rotation direction of the first coupling member 610, and the fifth surface 624c is not arranged further away from the photosensitive drum 603 than the shield surface 617a of the shield part 617, which can effectively avoid the problem that the force bearing claw 21 is blocked by the upstream end of the third surface 614c after being out of contact with the fifth surface 624c, and can also avoid the problem that the force bearing claw 21 is blocked by the fifth surface 624c after being out of contact with the shield surface 617a of the shield part 617. Preferably, the fifth surface 624c is arranged further away from the photosensitive drum 603 than the upstream end of the third surface 614c, and the fifth surface 624c is substantially flush with the shield surface 617a of the shield part 617 to form a height difference in the left-right direction between the third surface 614c and the fifth surface 624c. The force bearing claw 21 may smoothly enter the fifth surface 624c after being out of contact with the shield surface 617a of the shield part 617, and then may stably pass over the gap 630 after being out of contact with the fifth surface 624c.

It can be known from the previous embodiments that the fourth surface 624d is configured as an inclined surface with substantially the same inclination direction as the second surface 614b, the second surface 614b is an inclined surface that gradually moves away from the photosensitive drum 603 as the second surface 614b moves downstream in the rotation direction, and the fourth surface 624d is also an inclined surface that gradually moves away from the photosensitive drum 603 as the fourth surface 624d moves downstream in the rotation direction. Preferably, the upstream end of the fourth surface 624d is adjacent to the end surface 611. When the force bearing claw 21 is out of contact with the third surface 614c of the first protruding portion 614 and fails to successfully engage with the second surface 614b, the fourth surface 624d adjacent to the end surface 611 may guide the force bearing claw 21 to come into contact with the third surface 614c of another first protruding portion 614. Finally, the force bearing claw 21 may be guided by the third surface 614c again to engage with the second surface 614b.

Further, in the rotation direction of the first coupling member 610, the upstream end of the first protruding portion 614 has a side surface facing the upstream side of the first coupling member 610, and the first surface 614a is arranged on the side surface. A protrusion (not shown) is formed protruding from the side surface toward the upstream side of the first coupling member 610 to further enhance the use strength of the first protruding portion 614 and prevent the first protruding portion 614 from breaking after being subjected to force.

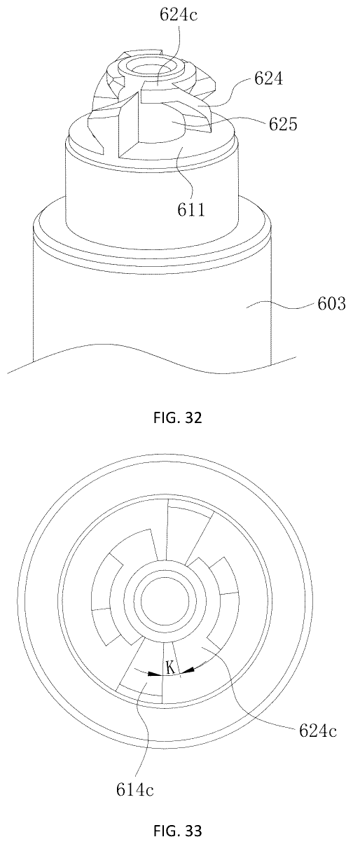

Further, as shown in FIG. 32, a groove 625 is further formed on the second protruding portion 624 of the first coupling member 610. The groove 625 is configured as a groove recessed from the radial outer peripheral surface of the second protrusion 625 toward a first rotation axis close to the first coupling member 610. In the first direction, the groove 625 is arranged at a position closer to the photosensitive drum 631 than the second protruding portion surface 631. Specifically, the groove 625 is arranged between the fourth surface 624d and the end surface 611. After adopting this structure, the material requirement of the first coupling member 610 is further saved, and the production cost is further reduced.

Further, when viewed from right to left, a notch 616 is formed between shield surfaces 617a of a pair of shield parts 617, and the notch 616 has an overlapping part with the third surface 614c, which facilitates the force bearing claw 21 to more easily enter from the gap 66 and be guided by the third surface 614c, thereby making it easier to engage with the second surface 614b.

Further, a second line segment that is perpendicular to the first direction and connects the third surface 614c and the fourth surface 624d is made, and the shortest distance of the second line segment is M, where 1 mm<M<4 mm, so as to ensure that the groove formed between the second surface 614b and the fourth surface 624d is large enough, improve the tolerance of the force bearing claw 21 abutting against the second surface 614b, and avoid such a situation that when the distance between the two is too small, it is difficult for the force bearing claw 21 to enter the groove formed by the fourth surface 624d and the second surface 614b. On the contrary, the force bearing claw 21 is easily guided away by the fourth surface 624d during the engagement process with the second surface 614b, and becomes difficult to engage. More preferably, 2 mm<M<3 mm. In other words, when a first side surface of the free end of the force bearing claw 21 (i.e., the surface facing the second surface 614b in the rotation direction of the first coupling member 610) abuts against the second surface 614b, the spacing distance between a second side surface of the free end of the force bearing claw 21 (i.e., the surface facing the fourth surface 624d in the rotation direction of the first coupling member 610) and the fourth surface 624d is V, where 0<V<2 mm, preferably, 0.1<V<1 mm.

Further, a first point is provided at the upstream end of the third surface 614c in the rotation direction of the first coupling member 610, and a second point is provided at the downstream end of the third surface 614c in the rotation direction of the first coupling member 610. When measured in a direction perpendicular to the first direction, the first point and the second point are both the points on the third surface 614c that are farthest from the rotation axis of the first coupling member 610. A third line segment connecting the first point and the second point is made, and the length of the third line segment is W, where 3 mm<W<4 mm. On the one hand, it is to avoid the problem that when W is too small, the extension length of the third surface 614c is too small to guide the force bearing claw 21 well. On the other hand, it is also to avoid the problem that when W is too large, the size of the groove between the fourth surface 624d and the second surface 614b is compressed, making it difficult for the force bearing claw 21 to enter, thereby affecting the engagement of the force bearing claw 21 with the second surface 614b.

### Embodiment 6

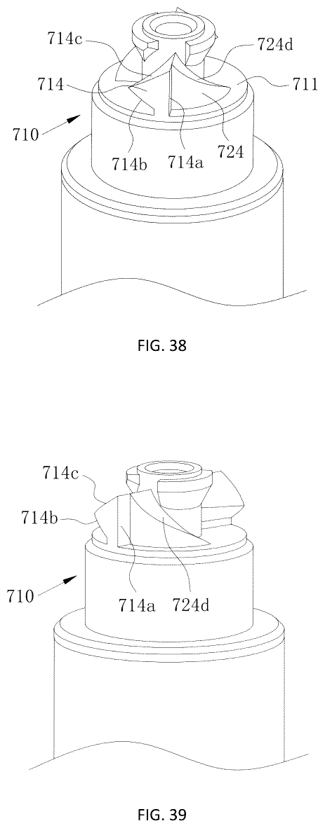

As shown in FIGS. 38 and 39, a process cartridge in Embodiment 6 of the present disclosure is shown. The parts of the first coupling member 710 of the process cartridge in this embodiment that are the same as those in Embodiment 5 above will not be described in detail. The difference is that the first protruding portion 714 and the second protruding portion 724 of the first coupling member 710 are adjacent to each other, that is, in the rotation direction of the first coupling member 710, the upstream end of the first protruding portion 714 and the downstream end of the second protruding portion 724 are connected to each other. Therefore, in this embodiment, the first protruding portion 714 and the second protruding portion 724 can be understood as one protruding portion, that is, the protruding portion includes a first surface 714a, a second surface 714b, a third surface 714c and a fourth surface 724d, wherein the fourth surface 724d is arranged on the upstream side of the first surface 714a in the rotation direction of the first coupling member 710, and the fourth surface 724d is configured to extend in the rotation direction of the first coupling member 710 from the position of an adjacent surface 711 to the upstream end adjacent to the third surface 714c, that is, the third surface 714c and the fourth surface 724d are adjacent to each other. That is, on the protruding portion, the upstream side of the third surface 714c is not provided with a surface with the same inclination direction as the third surface 714c.

This embodiment provides a first coupling member 710 that is different from that in the above-mentioned embodiments. The fourth surface 724d of the first coupling member 710 may also guide the force bearing claw 21 to the third surface 714c and then engage with the second surface 714b.

### Embodiment 7

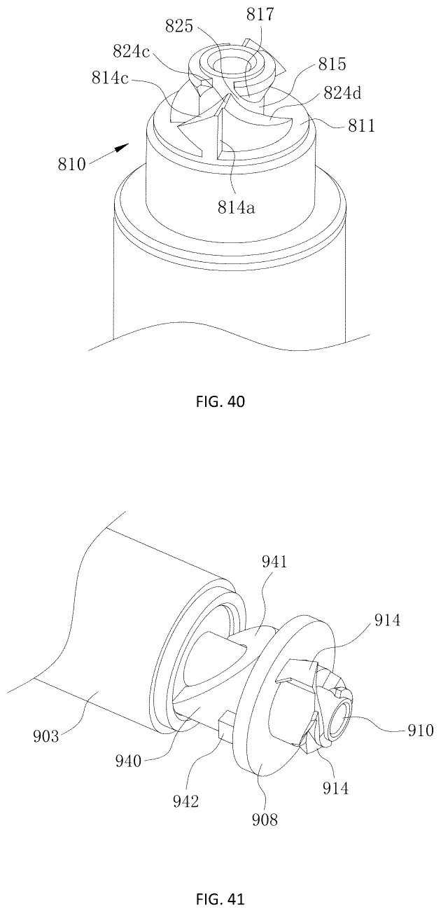

As shown in FIG. 40, a process cartridge in Embodiment 7 of the present disclosure is shown. The parts of the first coupling member 810 of the process cartridge in this embodiment that are the same as those in Embodiment 6 above will not described in detail. The difference is that the first coupling member 810 further includes a fifth surface 824c arranged between the fourth surface 824d and the first surface 814a in the rotation direction of the first coupling member 810, and the fifth surface 824c is arranged crosswise with both the fourth surface 824d and the first surface 814a. Specifically, the fifth surface 824c is arranged to extend in the rotation direction of the first coupling member 810 from the downstream end of the fourth surface 824d to the downstream side of the first surface 814a, so that the fifth surface 824c may be used to connect the fourth surface 824d and the first surface 814a, and a smooth transition area may thus be formed between the fourth surface 824d and the first surface 814a, so as to avoid breakage and damage at the connection between the fourth surface 824d and the first surface 814a during molding and use. Further, the fifth surface 824c is configured as a plane perpendicular to the left-right direction to more smoothly connect the fourth surface 824d and the first surface 814a.

The right end of the positioning post 815 of the first coupling member 810 is also provided with a shield part 817, which is configured as a protrusion protruding outward from the outer peripheral surface of the positioning post 815 and extends around the first rotation axis of the first coupling member 810. During the coupling process of the first coupling member 810 and the driving force applying member 10, the extended end of the force bearing claw 21 may be blocked by the shield surface of the shield part 817, so that it can only cut in according to a predetermined position. This is substantially the same as the function of the shield part in the above-mentioned embodiments, and will not be described in detail here. Further, a guide groove 825 is formed between the shield part 817 and the fourth surface 824d, and the guide groove 825 can be understood as a groove structure formed by the shield part in the above-mentioned embodiment and the fourth surface 824d after a part of the material of the shield part is cut off. Specifically, the shield portion 817, the fourth surface 824d and the outer surface of the positioning post 815 together form a guide groove 825, and the guide groove 825 is a spiral guide groove, which has substantially the same spiral inclination direction as the fourth surface 824d. That is, the guide groove 825 is configured to spiral along a direction from left to right in the rotation direction of the first coupling member 810. During the coupling process of the first coupling member 810 and the driving force applying member 10, the force bearing claw 21 may abut against the fourth surface 824d while being inserted into the guide groove 825 and slide under the guidance of the guide groove 825, which helps the force bearing claw 21 to slide onto the third surface 814c more accurately and stably, and the coupling success rate and coupling speed of the first coupling member 810 and the driving force applying member 10 can be thus improved.

### Embodiment 8

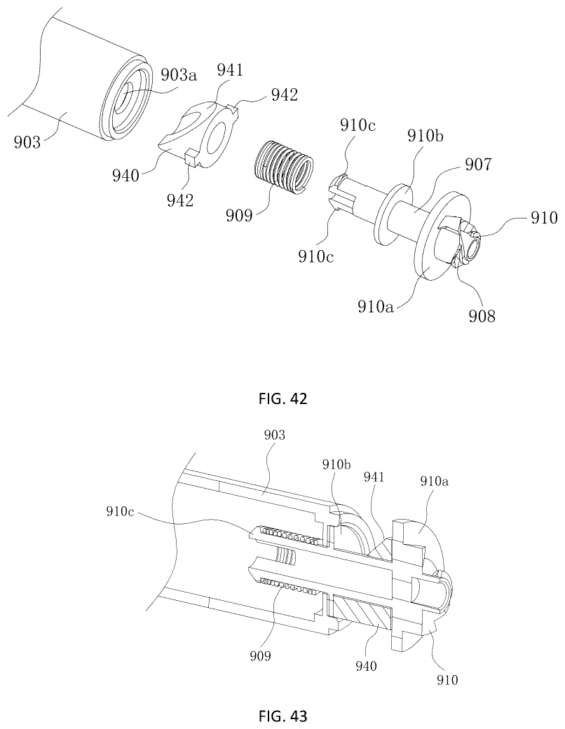

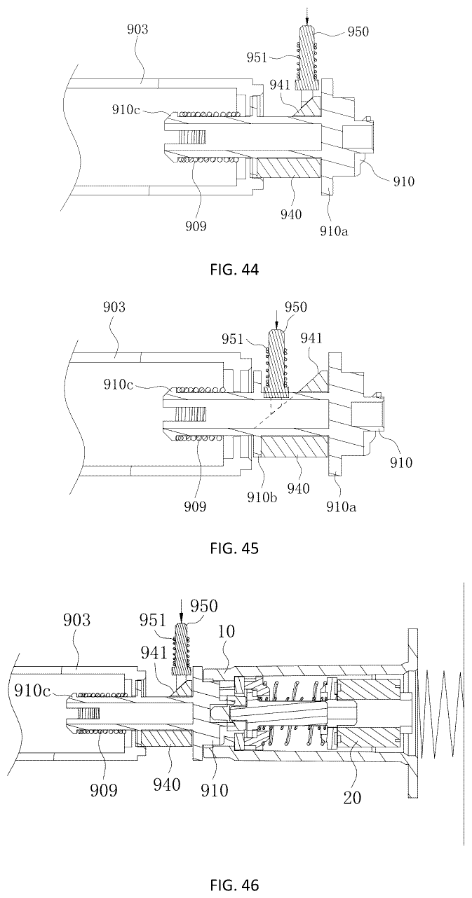

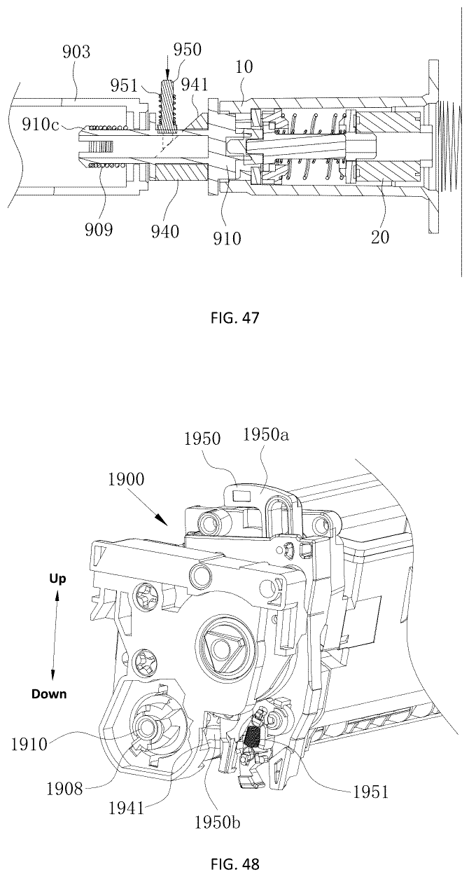

Next, Embodiment 8 of the present disclosure will be described in detail with reference to FIGS. 41-47. Embodiment 8 shows a process cartridge. The parts that are the same as the process cartridges in the above embodiments will not be described in detail in this embodiment. For example, the specific structure of the first coupling member 910 may be any structure of the first coupling member in Embodiments 1-7, which is not limiting. Therefore, the specific structure of the first coupling member 910 will not be described in detail in this embodiment. The difference is that the first coupling member 910 of the process cartridge in Embodiment 8 is configured as a retractable structure.

The first coupling member 910 is connected to the right end of the photosensitive drum 903 and may move in the left-right direction relative to the photosensitive drum 903. Specifically, the first coupling member 910 includes a coupling member 908 and an urged member 940 connected to the coupling member 908, wherein in addition to a pair of driven protrusions 914 described in the above embodiments, the coupling member 908 includes a shaft body 907 arranged on the left side of the driven protrusion 914. An elastic buckle 910c is arranged on the left end portion of the shaft body 907. The elastic buckle 910c is mounted inside the photosensitive drum 903 and may be blocked by the right end surface of the inside of the photosensitive drum 903, so that the coupling member 908 can be prevented from being separated from the photosensitive drum 903 from left to right in a natural state. In addition, the first coupling member 910 further includes a fifth elastic member 909 sleeved on the shaft body 907, and the fifth elastic member 909 is arranged and abutted between the elastic buckle 910c and the right surface of the inside of the photosensitive drum 903. The fifth elastic member 909 is configured to being capable of maintaining the coupling member 908 in a first position closer to the photosensitive drum 903 in the left-right direction before the first coupling member 910 receives external force. Preferably, the fifth elastic member 909 is a compression spring.

Furthermore, the shaft body 907 is further provided with a first limiting protrusion 910a and a second limiting protrusion 910b spaced apart along the length direction of the shaft body 907. The first limiting protrusion 910a and the second limiting protrusion 910b are arranged between the elastic buckle 910c and the driven protrusions 914 in the left-right direction. The two are configured to be substantially disc-shaped, and the urged member 940 mentioned above is limited on the shaft body 907 between the first limiting protrusion 910a and the second limiting protrusion 910b. Therefore, their positions relative to the shaft body 907 are maintained. Specifically, an urged member 940 includes an urged inclined surface 941, and the urged inclined surface 941 is arranged so that its plane intersects with the left-right direction and faces the left end of the process cartridge. The process cartridge further includes an urging member 950 which may move in a direction intersecting the left-right direction relative to the photosensitive drum 903. The urging member 950 is connected to a sixth elastic member 951, and the urging member 950 is configured to be movable between a position where the urged inclined surface 941 is not urged and a position where the urged inclined surface 941 is urged, in response to the opening/closing action of the door cover 4. When the urging member 950 overcomes the elastic force generated by the compression of the sixth elastic member 951 to urge the urged inclined surface 941, an urging component force that urges the urged member 940 and moves the coupling member 908 to the right can be generated. That is, after the door cover 4 of the image forming device 1 is closed, the urging member 950 may urge the urged member 940 and the coupling member 908 to move rightward from the retracted position to the extended position after overcoming the elastic force of the fifth elastic member 909. At this time, the coupling member 908 may urge the driving force applying member 10 to overcome the elastic force of the elastic member connected thereto and move rightward, so that the driven protrusion 914 of the first coupling member 910 and the driving protrusion 14 of the driving force applying member 10 maintain elastic abutment, and the two maintain stable coupling in the left-right direction, thereby improving the coupling stability of the two. After the door cover 4 of the image forming device 1 is opened, the urging member 950 may be reset by the sixth elastic member 951 to the position where the urged member 940 is not urged, that is, the urging force previously applied to the urged inclined surface 941 of the urged member 940 is removed. At this time, the coupling member 908 drives the urged member 940 to be reset to the retracted position by the elastic force of the fifth elastic member 909, so that the process cartridge can be taken out without causing disassembly interference with the image forming device 1. Further, the urged member 940 further includes an anti-rotation portion 942. The anti-rotation portion 942 is a protrusion formed on the urged member 940, which may be snapped onto the drum frame to prevent the urged member 940 from rotating along with the coupling member 908 and the photosensitive drum 903. That is, the urged member 940 is configured to be only movable leftward and rightward along with the coupling member 908, but not rotate along with it. This allows the urged inclined surface 941 of the urged member 940 to always remain facing the urging member 950, so that the urging member 950 can urge the urged inclined surface 941 of the urged member 940. Optionally, the structure of the anti-rotation portion 942 is not limited to the above protrusion structure, and it may be a groove structure or another structure that can cooperate with the protrusion on the drum frame, as long as it can achieve the technical effect of preventing the urged member 940 from rotating along with the coupling member 908.

### Embodiment 9

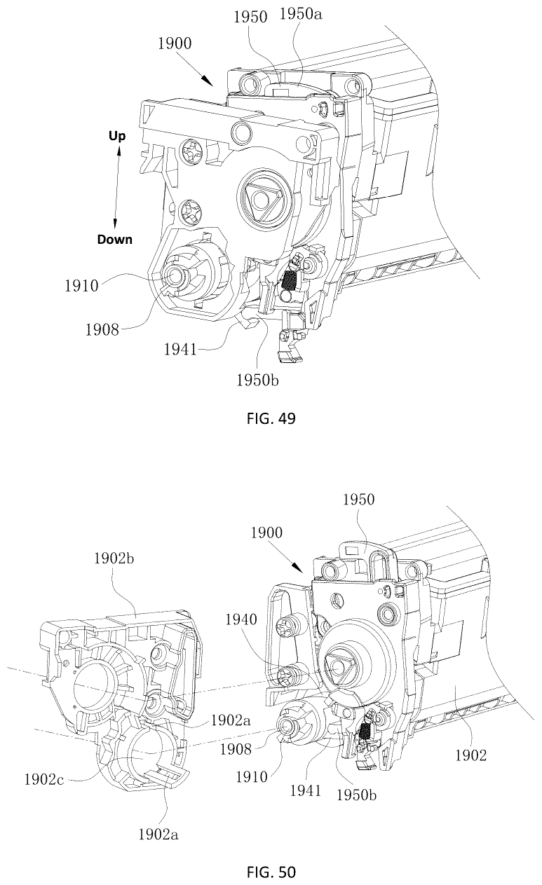

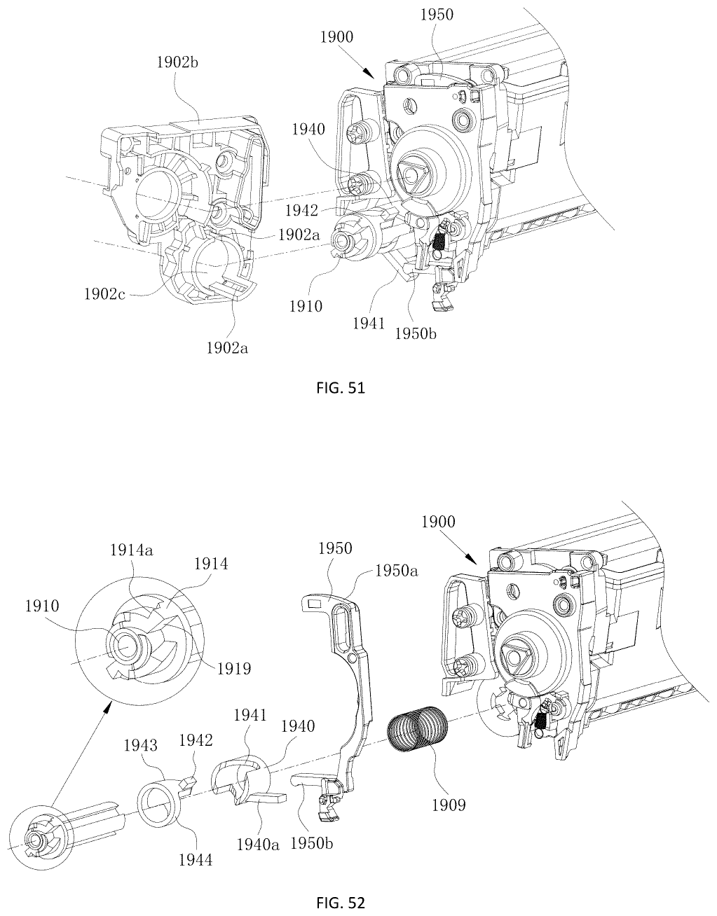

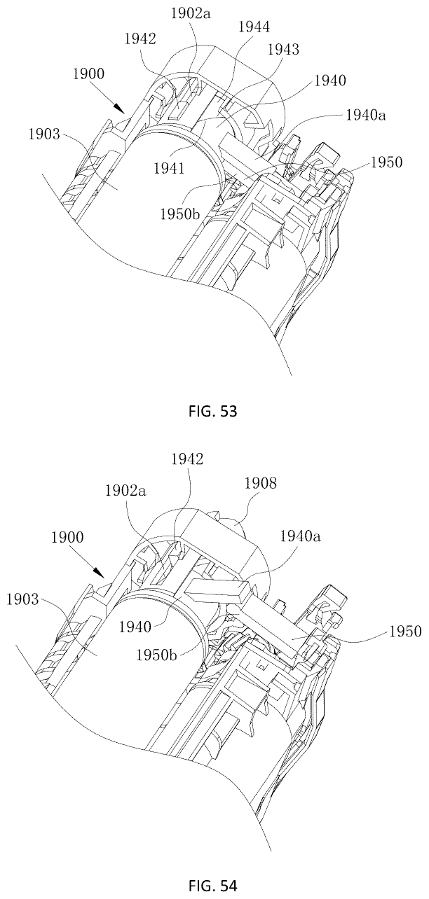

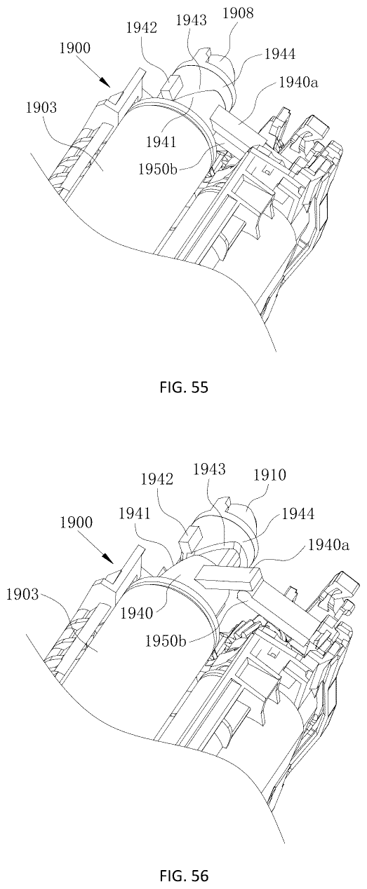

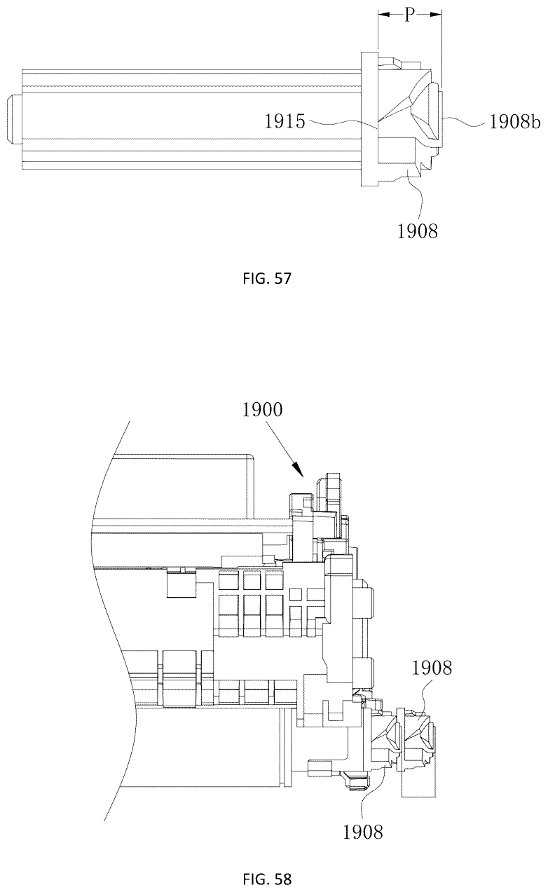

Next, a process cartridge 1900 in Embodiment 9 of the present disclosure will be described in detail with reference to FIGS. 48-58. The parts that are the same as the process cartridges in the above embodiments will not be described in detail in Embodiment 9. For example, the specific structure of the first coupling member 1910 may be any structure of the first coupling member in Embodiments 1-7, which is not limiting. Therefore, the specific structure of the first coupling member 1910 will not be described in detail in Embodiment 9. The difference is that a retractable structure that forces the first coupling member 1910 to extend or retract is different. Different retractable structures will be described in detail below.

The process cartridge 1900 includes an urging member 1950 movably mounted on the drum frame 1902. The urging member 1950 is configured as a rod spanning the upper and lower sides of the drum frame 1902, that is, the urging member 1950 is configured as an urging rod. The urging rod 1950 includes a force receiving portion 1950a located at its upper end. The force receiving portion 1950a may receive an urging force from the upper end of the process cartridge 1900 in the image forming device 1, and can force the urging member 1950 to move downward from a first position to a second position in the up-down direction relative to the drum frame 1902. It is worth mentioning that the lower end of the urging member 1950 may receive the urging force in the front-rear direction of the image forming device 1, and a separator (not shown) arranged in the process cartridge may move in response to the movement of the urging member 1950, and can switch the developing roller and the photosensitive drum 1903 from a contact position where they are in contact with each other to a separated position where they are separated from each other, and vice versa. That is, the urging member 1950 has multiple functions. This configuration may make the process cartridge 1900 more integrated, facilitating the miniaturization of the process cartridge 1900. The urging member 1950 further includes an urging portion 1950b located at a lower end thereof. The urging portion 1950b is formed protruding outward from the lower end of the urging member 1950 in a direction intersecting the length direction of the urging member 1950, and is configured as an urging protrusion. When the urging member 1950 is forced to move downward, the urging portion 1950b may also move downward. The process cartridge 1900 further includes a sixth elastic member 1951 connected to the urging member 1950. When the urging member 1950 is not subjected to an external force, an elastic force generated by the sixth elastic member 1951 may act on the urging member 1950, thereby forcing the urging member 1950 to maintain the first position. When the urging member 1950 is subjected to an external force, the urging member 1950 may overcome the elastic force of the sixth elastic member to move from the first position to the second position. After the external force applied to the urging member 1950 is removed, the elastic force generated by the sixth elastic member 1951 is released and may be applied to the urging member 1950, forcing the urging member 1950 to reset and move from the second position to the first position. In other words, the sixth elastic member 1951 may be used to reset the urging member 1950.

The process cartridge 1900 further includes an urged member arranged at the lower side of the process cartridge 1900. The urged member includes a first urged member 1940 and a second urged member 1944 arranged coaxially with the coupling member 1908, wherein the first urged member 1940 has an annular basic structure, including an urged portion 1940a that may receive the urging force of the urging member 1950. The urged portion 1940a is configured as a protrusion formed by protruding outward from the outer peripheral surface of the first urged member 1940 along a radial direction thereof, i.e., an urged protrusion 1940a. After the urged protrusion 1940a is urged by the urging portion 1950b of the urging member 1950, the first urged member 1940 may rotate about the rotation axis of the coupling member 1908 by a certain angle. Specifically, when viewed from right to left, the first urged member 1940 may rotate by a certain angle in the clockwise direction. In other words, the first urged member 1940 may rotate in response to the movement of the urging member 1950. An inclined surface inclined relative to the left-right direction is further provided on the first urged member 1940, and the inclined surface is defined as a first urged member inclined surface 1941.

The second urged member 1944 is provided with a second urged member inclined surface 1943 in contact with the first urged member inclined surface 1941. The first urged member inclined surface 1941 and the second urged member inclined surface 1943 are arranged substantially in parallel. When the first urged member 1940 is urged by the urging member 1950 to rotate, the second urged member 1944 is urged by the first urged member inclined surface 1941 through the second urged member inclined surface 1943 to move in the left-right direction. Specifically, the second urged member 1944 may move from the first position to the second position from left to right. That is, the second urged member 1944 may move in response to the movement of the first urged member 1940. Optionally, an inclined surface may be provided on only one of the first urged member 1940 and the second urged member 1944, which can also achieve the technical effect of urging the second urged member 1944 to move from the first position to the second position. This is not a limitation. It is just because providing the inclined surface on each of the first urged member and the second urged member in this embodiment has the beneficial effect of improving the sliding smoothness of the second urged member 1944 and reducing the wear between the two, and a preferred implementation is adopted. Further, to prevent the second urged member 1944 from rotating during the movement from the first position to the second position, it is caused to rotate together with the first urged member 1940, thereby resulting in the problem that the second urged member 1944 is difficult to extend or even cannot extend. A clamped portion 1942 is provided on the second urged member 1944. The clamped portion 1942 is a protrusion formed on the second urged member 1944, i.e., a first clamped protrusion 1942, and a pair of first clamped protrusions are provided. Correspondingly, at least one clamping portion 1902a configured as a groove, i.e., a first clamping groove, is provided on the protective cover 1902b, and a pair of first clamping grooves are also provided. It is worth mentioning that the protective cover 1902b is a cover member provided at the right end of the process cartridge 1900, which may cover at least a part of a gear train of the process cartridge 1900. An exposure hole 1902c is formed on the protective cover 1902b. The exposure hole 1902c can expose the coupling member 1908 of the first coupling member 1910 to allow it to couple with the driving force applying member 10, and a pair of clamping portions 1902a are arranged opposite to each other on both sides of the exposure hole 1902c. The pair of clamping portions 1902a can be matched and clamped with a pair of clamped portions 1942 to limit the second urged member 1944 from rotating with the first urged member 1940. Optionally, the specific structures of the clamped portion 1942 configured as a protrusion and the clamping portion 1902a configured as a groove are interchangeable, that is, the clamped portion 1942 may be configured as a groove, and the clamping portion 1902a may be configured as a protrusion, which can also achieve the technical effect of limiting the rotation of the second urged member 1944.

The process cartridge 100 further includes a coupling member 1908 mounted at the right end of the photosensitive drum 1903 and capable of receiving the driving force of the image forming device 1 to rotate so that the photosensitive drum 1903 is rotated, and a fifth elastic member 1909 mounted on the coupling member 1908. The fifth elastic member 1909 is sleeved on the coupling member 1908. By providing an elastic buckle structure on the coupling member 1908, the coupling member 1908 is prevented from being separated from the photosensitive drum 1903, and the fifth elastic member 1909 is blocked from being separated from the coupling member 1908. When the urging member 1950 is not subjected to an external force, an elastic force generated by the fifth elastic member 1909 may maintain the coupling member 1908 in the retracted position to avoid interference with the image forming device 1 during the installation of the process cartridge 1900 to the image forming device 1. At the same time, after the urging force applied to the urging member 1950 is removed, the elastic force generated by the fifth elastic member 1909 is released, which may drive the coupling member 1908 to reset and move from the extended position to the retracted position. That is, the fifth elastic member 1909 may also be used to reset the moved coupling member 1908 to avoid the problem that when the process cartridge 1900 is disassembled from the image forming device 1, disassembly interference with the image forming device occurs so that the process cartridge cannot be disassembled. At least a part of the coupling member 1908 abuts against the right end of the second urged member 1944, and is configured to be movable in response to the movement of the second urged member 1944. That is, when the second urged member 1944 moves rightward, the coupling member 1908 may be urged to move rightward from the retracted position to the extended position. During the movement of the coupling member 1908, the coupling member 1908 may push the driving force applying member 10 rightward from the extended position to the retracted position under the action of overcoming the elastic force of the elastic member connected thereto. During the coupling and rotation process of the two, elastic contact is maintained and the coupling member 1908 may maintain the driving force applying member 10 in the retracted position, which improves the coupling stability of the two and avoids mutual separation. In this embodiment, the driving force applying member 10 in the retracted position is closer to the right end side wall of the image forming device in the left-right direction than the driving force applying member 10 in the extended position.

In this embodiment, the first surface 1614a of the first coupling member 1910 and an engaging surface 1919 are also opposite surfaces formed on the driving protrusion 1914, and the two face the upstream side and the downstream side in the rotation direction of the coupling member 1908, respectively, which is similar to those in the above-mentioned embodiments and will not be described in detail here. However, the difference is that the plane where the engaging surface 1919 in this embodiment is located is substantially parallel to the left-right direction. After the coupling member 1908 is coupled with the driving force applying member 10, the engaging surface 1919 may engage with the force bearing claw 21 of the braking force applying member 20 and drive the force bearing claw 21 to rotate together. Therefore, while ensuring that the coupling between the coupling member 1908 and the driving force applying member 10 is stable, the engaging surface 1919 is configured to be substantially parallel to the left-right direction, which helps to simplify the structure of the coupling member 1908.

Moreover, the coupling member 2108 includes the abutment surface 1915 described in the aforementioned embodiments, and the distance between the abutment surface 1915 and the right side surface 1908b of the coupling member 1908 is P, where 2 mm≤P≤5 mm. In the case of P being within this range, when the process cartridge 1900 is mounted in the image forming device 1, the abutment surface 1915 may abut against the force bearing claw 21 at the free end of the force bearing member and urge the force bearing member to retract to the right, so that the coupling member 1908 and the photosensitive drum 1903 connected to the coupling member 1908 will no longer receive the damping output from the image forming device 1, and no abnormal sound caused by frequent engagement and disengagement between protrusions will be generated during the rotation process.

Further, a telescopic stroke of the coupling member 1908 is defined as L, and the telescopic stroke is the distance between the coupling member 1908 when it is in the retracted position and the coupling member 1908 when it is in the maximum extended position. In this embodiment, the maximum telescopic stroke L of the coupling member 1908 is 12 mm. However, to ensure the coupling stability between the coupling member 1908 and the driving force applying member 10, further, the minimum telescopic stroke L of the coupling member 1908 is 2 mm. That is, 2 mm≤L≤12 mm.

To further improve the printing quality of the process cartridge 1900, the process cartridge 1900 further includes ninth elastic members (not shown) connected between the developing cartridge supporting the developing roller and the drum cartridge supporting the photosensitive drum 1903. The ninth elastic members are arranged at the left and right ends of the process cartridge 1900, respectively, to ensure the uniformity of the developer conveyed to the left and right sides of the photosensitive drum 1903. Preferably, the ninth elastic member is a tension spring or a compression spring, which has the advantages of low cost, stable performance, etc. In the process cartridge 1900, an elastic force generated by the ninth elastic member is applied to the developing cartridge and the drum cartridge, and is configured to maintain the developing roller and the photosensitive drum 1903 close to each other, so that the developing roller and the photosensitive drum 1903 maintain close contact, and the effect of the developer conveyed to the photosensitive drum 1903 by the developing roller is improved.

Next, the specific action process of the first coupling member 1910 during the installation and disassembly of the process cartridge 1900 will be described. First, the process cartridge 1900 is mounted in the image forming device 1 with the coupling member 1908 in the retracted position. At this time, the first coupling member 1910 and the driving force applying member 10 face each other in the left-right direction and are spaced apart by a certain distance. After the door cover 4 of the image forming device 1 is closed, on the one hand, the driving force applying member 10 extends and moves in a direction close to the first coupling member 1910; on the other hand, the force receiving portion 1950a of the urging member 1950 of the process cartridge 1900 receives the urging force from the image forming device 1, which will force the urging member 1950 to move from the first position to the second position from top to bottom under the action of overcoming the elastic force of the sixth elastic member 1951. Almost at the same time, the urging portion 1950b located at the lower end of the urging member 1950 urges the urged portion 1940a of the first urged member 1940, and the first urged member 1940 rotates in response to the movement of the urging member 1950. Subsequently, the first urged member inclined surface 1941 of the first urged member 1940 urges the second urging member inclined surface 1943 of the second urged member 1944, which will generate a rightward urging force. The urging force will force the second urged member 1944 to move from left to right, and then the second urged member 1944 will push the coupling member 1908 to overcome the elastic force of the fifth elastic member 1909 and move from the retracted position to the extended position from left to right. The coupling member 1908 is in the extended position and urges the driving force applying member 10 to retract, so that the coupling member 1908 and the driving force applying member 10 maintain elastic contact and coupling. Therefore, the coupling member 1908 may stably receive the rotational driving force of the driving force applying member 10, and at this time, the abutment surface 1915 of the coupling member 1908 may further urge the force bearing member to retract, so that the force bearing member and the connecting shaft 40 are axially disengaged from each other, and the two may rotate relative to each other. As the force bearing member further retracts, the force bearing member pushes the connecting shaft 40 to retract together, until a second protrusion 40b at the right end of the connecting shaft 40 is axially disengaged from a third protrusion 10a of the driving force applying member 10 matched therewith. At this time, the driving force applying member 10 does not directly drive the connecting shaft 40 to rotate through the third protrusion 10a. Even if the force bearing member is subsequently driven to rotate by the coupling member 1908, the force bearing member and the connecting shaft 40 have previously completed axial disengagement. Therefore, the connecting shaft 40 still will not rotate, so that the damper 44 cannot be driven to rotate, and finally, the coupling member 1908 and the photosensitive drum 1903 connected thereto will not receive the damping in the image forming device 1. The specific action of the first coupling member 1910 when the process cartridge 1900 is disassembled from the image forming device 1 is substantially opposite to the action of the first coupling member when the process cartridge 1900 is mounted to the image forming device 1, and will not be described in detail here.

### Embodiment 10

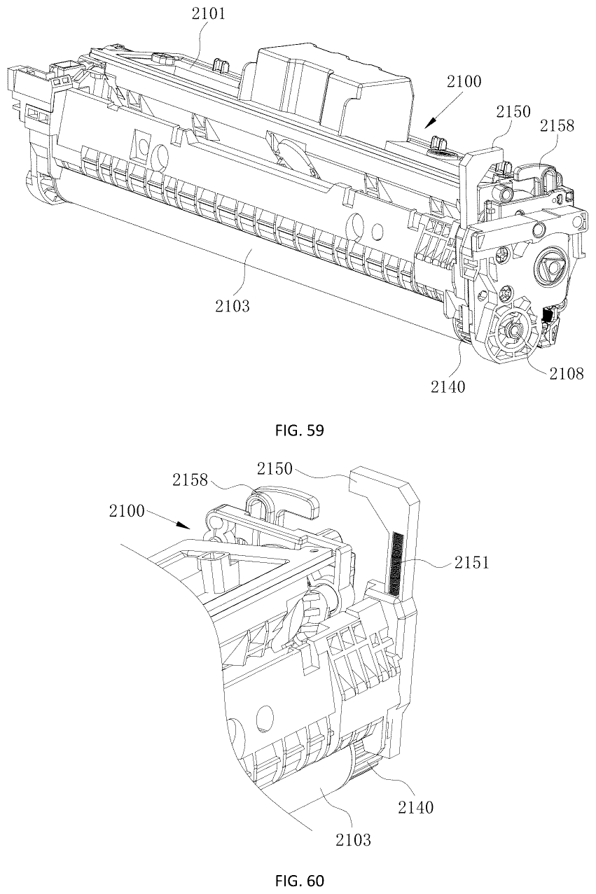

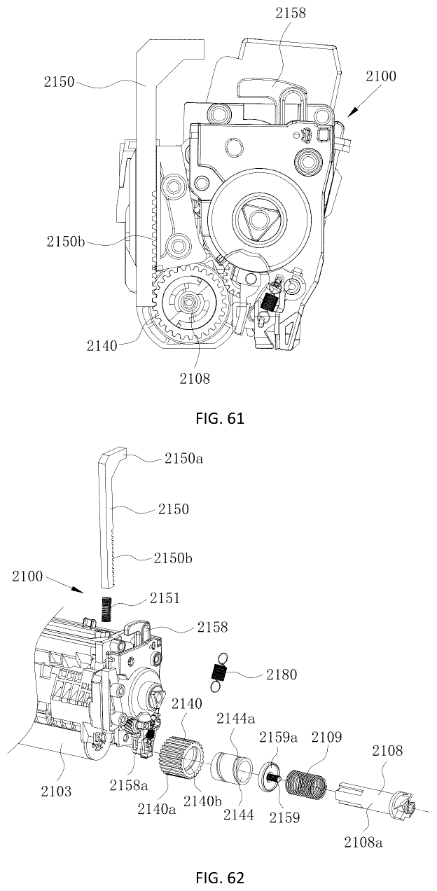

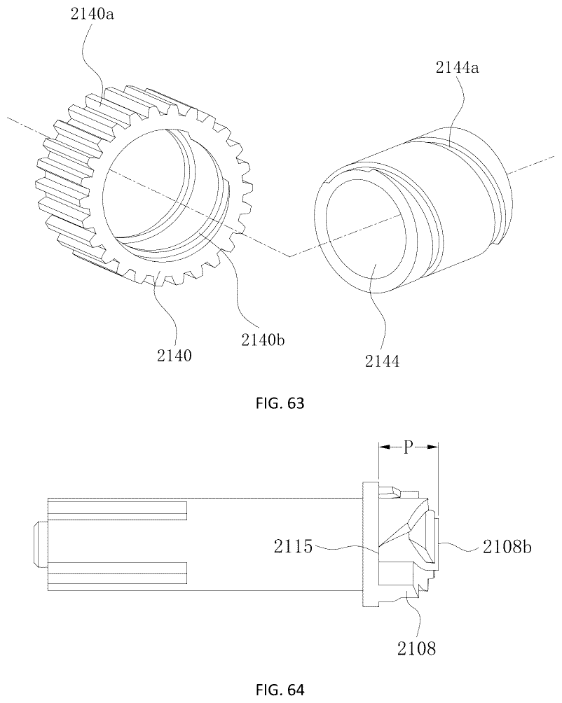

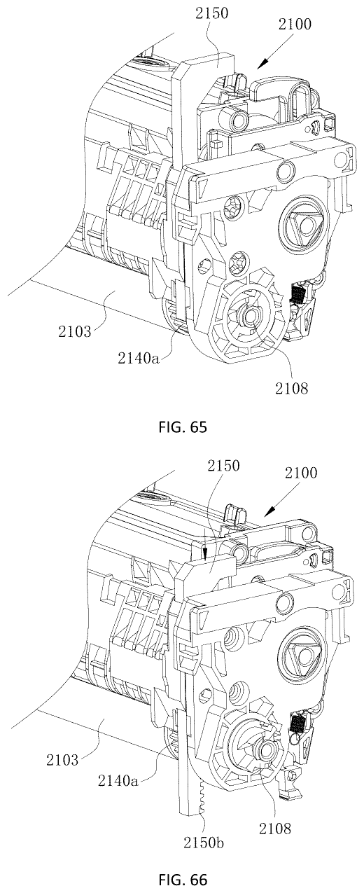

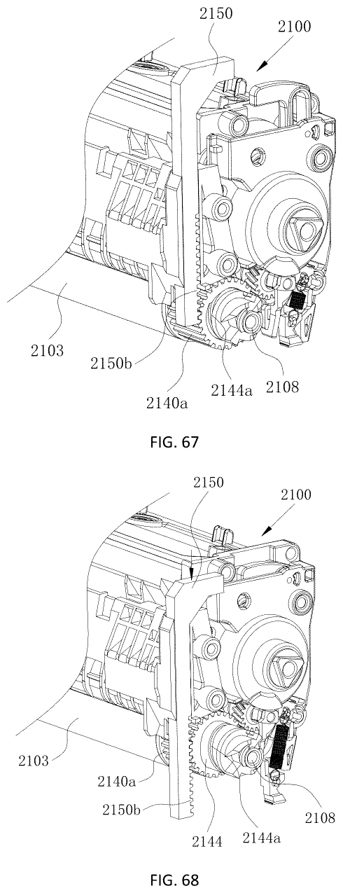

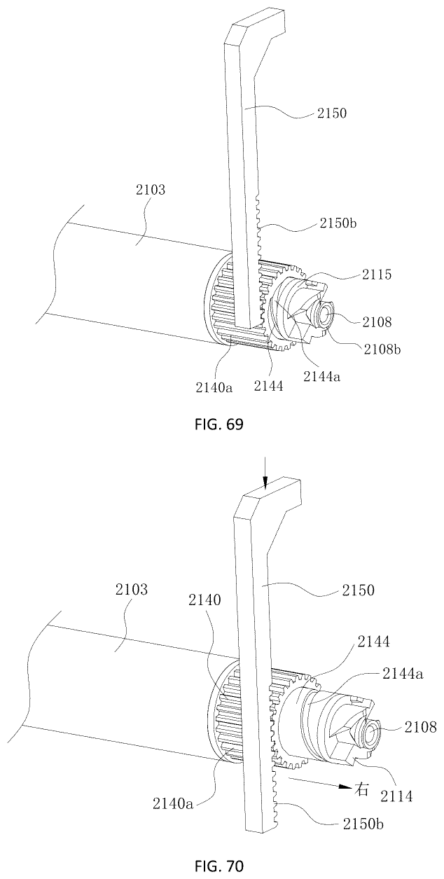

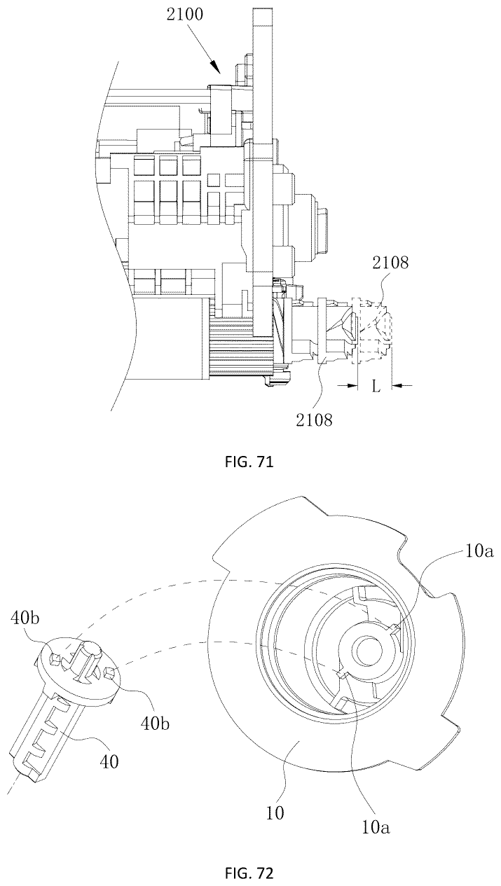

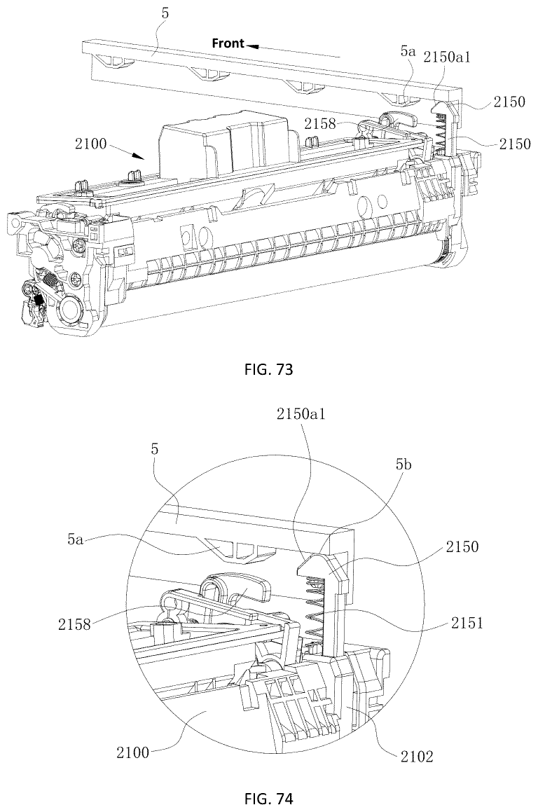

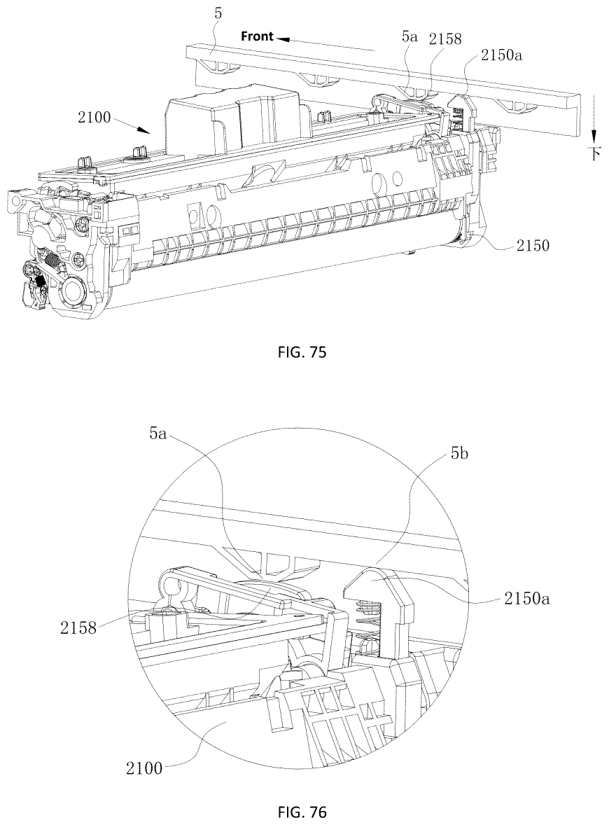

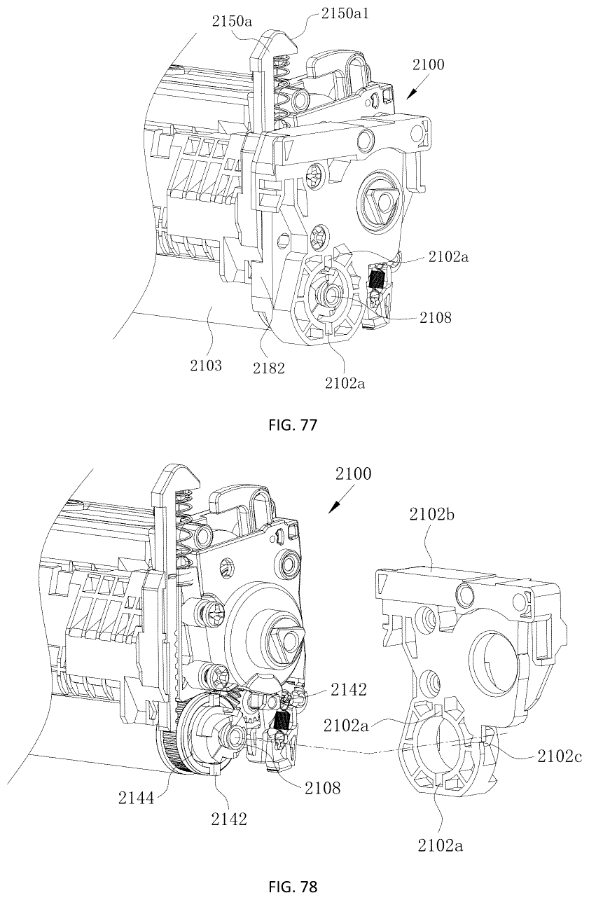

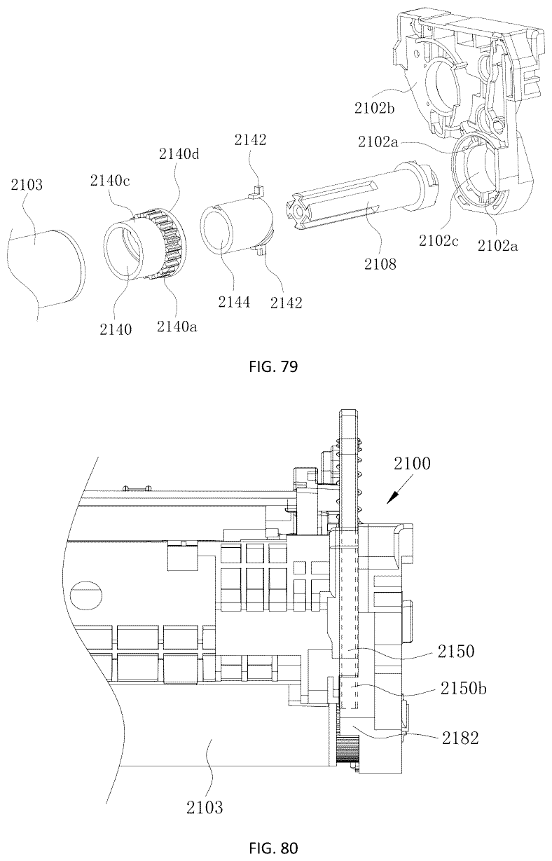

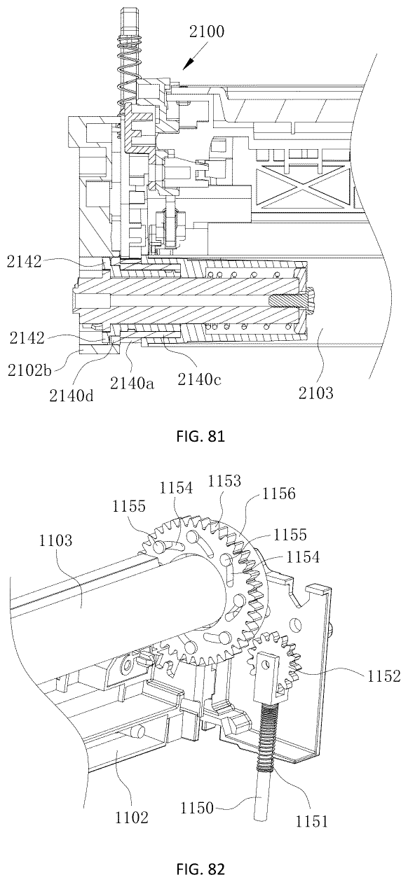

Embodiment 10 provides a process cartridge 2100. Next, the process cartridge 2100 will be described in detail with reference to FIGS. 59-81. The parts that are the same as the process cartridges in the above embodiments will not be described in detail in Embodiment 10. For example, the specific structure of the first coupling member 2110 may be any structure of the first coupling member in Embodiments 1-7, which is not limiting. Therefore, the specific structure of the first coupling member 2110 will not be described in detail in Embodiment 10. The difference is that a retractable structure that forces the first coupling member 2110 to extend or retract is different. Different retractable structures will be described in detail below.

Before the process cartridge 2100 is described in detail, the structure of the image forming device 1 described in detail above is first introduced. The pressing members 5 are arranged on the left and right sides of the image forming device 1, respectively, and are placed above the process cartridge 2100 when the process cartridge 2100 is mounted in the image forming device 1. Since the pressing members 5 on the left and right sides have substantially the same structure, only the pressing member 5 on the right side is used as an example for description. Specifically, the pressing member 5 is configured so that its length direction extends in the front-rear direction, and the pressing member 5 has a plurality of pressable and movable members 2158 and is configured as a first pressing portion 5a protruding downward. The plurality of first pressing portions 5a are arranged at intervals in the front-rear direction, and the pressing member 5 further has a plurality of second pressing portions 5b arranged at intervals in the front-rear direction. That is, the pressing member 5 has multiple groups of pressing portions, each group of pressing portions including a first pressing portion 5a and a second pressing portion 5b. In the same group of pressing portions, the first pressing portion 5a is arranged closer to the lower side of the image forming device 1 in the up-down direction than the second pressing portion 5b, and the first pressing portion 5a is arranged on the front side of the second pressing portion 5b in the front-rear direction.

The process cartridge 2100 includes an urging member 2150 arranged at the right end of a frame. The above-mentioned frame includes a developing frame 2101, a drum frame 2102 and protective covers 2102b respectively arranged at the left and right ends of the process cartridge 2100. Further, the urging member 2150 is movably supported on the drum frame 2102 relative to the drum frame 2102. Preferably, the urging member 2150 is an urging rod and is made of a low-cost plastic material. Optionally, it may also be made of a metal material, such as zinc alloy, which has strong strength and rigidity and resistance to deformation, and can greatly improve the service life and bending resistance of the urging member 2150. The urging member 2150 is configured to extend from the upper side to the lower side of the drum frame 2102, and be movable between a first position and a second position in the up-down direction relative to the frame. At least a part of the urging member 2150 located at the second position is closer to the frame 2101 in the up-down direction relative to the urging member 2150 located at the first position. The urging member 2101 includes a force receiving portion 2150a arranged at its upper end and protruding out of the frame, a rod portion 2150c arranged at the lower end of the force receiving portion 2150a and extending in the up-down direction, and an urging portion 2150b arranged on the rod portion 2150c. The force receiving portion 2150a may receive a pressing force from the pressing member 5 from top to bottom to force the urging member 2150 to move from the first position to the second position, and the urging portion 2150b is configured as a plurality of teeth arranged in the up-down direction. In other words, the urging portion 21501b can be understood as a rack. It is worth mentioning that when the process cartridge 2100 is mounted in the tray 3 and the tray 3 is not pushed into the image forming device 1, the force receiving portion 2150a of the urging member 2150 is located on the upper side of the first pressing portion 5a in the up-down direction. That is, when projected along the front-rear direction, the force receiving portion 2150a of the urging member 2150 has an overlapping part with the first pressing portion 5a. When the process cartridge 2100 is mounted in the image forming device 1 from rear to front in this posture, the upper end portion of the urging member 2150 will interfere with the first pressing portion 5a during the installation. Therefore, the urging member 2150 in this embodiment is further provided with a guide end surface 2150a1. The guide end surface 2150 is arranged on the upper front side of the urging member 2150, that is, it is arranged on the downstream side of the urging member 2150 in the installation direction of the process cartridge 2100. The guide end surface 2150a1 is configured as a surface inclined relative to the front-rear direction, at least a part of which faces the top of the process cartridge 2100. In the process of mounting the process cartridge 2100 from rear to front to the image forming device 1, the urging member 2150 may overcome the elastic force of the sixth elastic member 2151 (to be introduced later) under the guidance of the guide end surface 2150a1 and smoothly pass over the first pressing portion 5a. Therefore, it can be known that the guide end surface 2150a1 has the function of guiding the installation of the urging member 2150 to avoid installation interference.

A movable member 2158 different from the urging member 2150 is further provided at the right end of the frame 2101. The force receiving portion at the upper end of the movable member 2158 may also receive the pressing force from the first pressing portion 5a from top to bottom in the image forming device 1 to force the movable member 2158 to move between the first position and the second position in the up-down direction relative to the frame 2101. When the movable member 2158 is located at the second position, the lower end of the movable member 2158 may receive the urging force along the front-rear direction in the image forming device 1. The separator provided in the process cartridge may move in response to the movement of the movable member 2158, and may switch the developing roller and the photosensitive drum 2103 from a contact position where they are in contact with each other to a separated position where they are separated from each other. The lower end of the force receiving portion of the movable member 2158 is a rod portion extending in the up-down direction, and the rod portion 2150c of the urging member 2150 is arranged at the rear end of the rod portion of the movable member 2158 in the front-rear direction. Further, the urging member 2150 is arranged at the rear end of the movable member 2158 in the front-rear direction, and, when viewed along the left-right direction, at least a part of the urging member 2150 is arranged at the upper end of the movable member 2158. Specifically, the upper end of the urging member 2150 is arranged closer to the top than the upper end of the movable member 2158. That is, the urging member 2150 protrudes more from the frame 2101 than the movable member 2158, which allows the urging member 2150 to have a larger moving stroke in the up-down direction.

The process cartridge 2100 further includes a sixth elastic member 2151 arranged between the urging member 2150 and the drum frame 2102. The sixth elastic member 2151 is arranged on the upper side of the drum frame 2102. When the urging member 2150 is not subjected to an external force, the elastic force generated by the sixth elastic member 2151 is applied to the urging member 2150 so that the urging member 2150 can be kept in the first position. However, as the door cover 4 of the image forming device 1 is closed, the pressing member 5 moves downward in response to the closing of the door cover 4 and presses the force receiving portion 2150a of the urging member 2150. The urging member 2150 may overcome the elastic force of the sixth elastic member 2151 and move from the first position to the second position. After the pressing force applied to the urging member 2150 is removed, the urging member 2150 may be reset to the first position from the second position under the elastic force of the sixth elastic member 2151. Further, a lubricant such as water-based oil may be applied to the urging portion 2150b of the urging member 2150 and the first urged portion 2140a of the first urged member 2140 to increase the sliding smoothness between the two and avoid jamming.

The first urged member 2140 is arranged at the right end of the photosensitive drum 2103 and coaxially with the photosensitive drum 2103. The first urged member 2140 is rotatable relative to the frame 2101 and the photosensitive drum 2103, and the first urged member 2140 is movable in the left-right direction relative to the photosensitive drum 2103. Specifically, the first urged member 2140 is generally a hollow cylinder, a plurality of first urging portions 2140a configured as gear teeth are arranged on the outer surface of the first urged member along its circumferential direction, and a spiral protrusion 2140b is provided on the inner surface of the first urged member 2140. In the process cartridge 2100, the urging portion 2150b of the urging member 2150 configured as a rack is kept engaged with the first urged portion 2140a of the first urged member 2140 configured as a gear tooth. In the process of the urging member 2150 moving from the first position to the second position, the urging member 2150 urges the first urged portion 2140a of the first urged member 2140 through the urging portion 2150b provided thereon, so that the first urged member 2140 may be driven to rotate relative to the frame 2101. Further, to prevent the photosensitive drum 2103 from having large radial runout during the rotation process of executing a printing task, which affects the printing quality, it is necessary to radially position the end of the photosensitive drum 2103 in this case. Taking the right end of the photosensitive drum 2103 as an example, it can be seen from the above that the first urged member 2140 is mounted at the right end portion of the photosensitive drum 2103, and the first urged member 2140 may be effectively radially positioned, thereby realizing the radial positioning of the photosensitive drum 2103. Therefore, the first urged member 2140 in this embodiment further includes a first extension portion 2140c and a second extension portion 2140d which are connected to the left and right ends of the first urged member 2140a and extend in the left-right direction, wherein the first extension portion 2140c may be inserted into the inner cavity of the photosensitive drum 2103 and mounted in a manner of matching therewith, and the second extension portion 2140d may be inserted into the exposure hole 2102c of the protective cover 2102b and mounted in a manner of matching therewith. At this time, both the left and right ends of the first urged member 2140 are limited and positioned, so that the radial runout of the photosensitive drum 2103 is suppressed. It is worth mentioning that to make the first urged member 2140 rotate more smoothly and reduce the friction resistance between the first urged member 2140 and the photosensitive drum 2103, while ensuring the radial positioning accuracy of the first urged member 2140, a lubricant such as water-based oil may also be applied to the first urged member 2140 to reduce the friction resistance between the two and improve the smoothness of rotation.

However, in the process of the urging member 2150 moving downward and pushing the first urged member 2140 to rotate, the urging member 2150 will inevitably encounter greater resistance, which may cause the longer urging member 2150 to bend and deform, causing it to slip in the process of pushing the first urged member 2140, thereby affecting the force transmission between the two. Therefore, a control portion 2182 is further provided in the process cartridge 2100 to block the urging member 2150 from bending and deforming outward. The control portion 2182 is specifically configured as a stopper formed on the frame and extending in the up-down direction in its length direction. The stopper may block and control the deformation of the urging member 2150. Further, when the urging member 2150 is not subjected to an external force, when viewed in the left-right direction, the control portion 2182 covers at least a part of the urging portion 2150b of the urging member 2150, and at least a part of the lower end of the urging member 2150 is covered by the control portion 2182 in the up-down direction. In other words, at least a part of the lower end of the urging member 2150 is retracted into the control portion 2182. Further, the control portion 2182 completely covers the urging portion 2150b and the lower end of the urging member 2150 in the up-down direction to enhance the control effect.

A second urged member 2144 configured as a hollow cylinder is further provided at the right end of the photosensitive drum 2103. The second urged member 2144 is coaxially arranged with the first urged member 2140 and mounted in the inner surface of the first urged member 2140. A spiral groove 2144a is provided on the outer circumferential surface of the second urged member 2144. The spiral groove 2144a may cooperate with the spiral protrusion 2140b of the first urged member 2140 in a matching manner. When the first urged member 2140 is driven to rotate, the second urged member 2144 can be driven to move from the first position to the second position from left to right in the left-right direction through the cooperation between the spiral groove 2144a provided thereon and the spiral protrusion 2140b of the first urged member 2140. That is, the second urged member 2144 may move in response to the movement of the first urged member 2140, or in other words, the second urged member 2144 may move in response to the movement of the urging member 2150. Optionally, a spiral groove may be provided on the first urged member 2140, and a spiral protrusion may be provided on the second urged member 2144. After the two cooperate with each other, the first urged member 2140 may also drive the second urged member 2144 to move from the first position to the second position from left to right. Further, to prevent the second urged member 2144 from rotating during the process of being driven and causing it to be difficult to stably move rightward, the outer surface of the second urged member 2144 in this embodiment is further provided with a clamped portion 2142 protruding outward. Preferably, a pair of clamped portions 2142 are provided, and the two are arranged on the outer surface of the second urged member 2144 at intervals in the circumferential direction of the second urged member 2144. Correspondingly, a pair of clamping portions 2102a are provided on the radial sides of the exposure hole 2102c of the protective cover 2102b, and the pair of clamping portions 2102a may be matched and clamped with the pair of clamped portions 2142 to limit the second urged member 2144 from rotating with the first urged member 2140. Optionally, the specific structures of the clamped portion 2142 configured as a protrusion and the clamping portion 2102a configured as a groove are interchangeable, that is, the clamped portion 2142 may be configured as a groove, and the clamping portion 2102a may be configured as a protrusion, which can also achieve the technical effect of limiting the rotation of the second urged member 2144.

The process cartridge 2100 further includes a coupling member 2108 mounted at the right end of the photosensitive drum 2103 and capable of receiving the driving force of the image forming device 1 to rotate so that the photosensitive drum 2103 is rotated, and a fifth elastic member 2109 mounted on the coupling member 2108. The fifth elastic member 2109 is sleeved on a column 2108a extending in the left-right direction of the coupling member 2108 and is blocked by a blocking member 2159a to prevent the fifth elastic member 2109 from being separated from the coupling member 2108. A locking member 2159 configured as a screw locks the blocking member 2159a on the coupling member 2108 to prevent it from being separated from the coupling member 2108. Of course, the fifth elastic member 2109 may also be blocked from being separated from the coupling member by providing an elastic buckle structure on the coupling member as in Embodiment 9 described previously, which is not a limitation. When the urging member 2150 is not subjected to an external force, the elastic force generated by the fifth elastic member 2109 may maintain the coupling member 2108 in the retracted position to avoid interference with the image forming device 1 during the installation of the process cartridge 2100 to the image forming device 1. At the same time, after the urging force applied to the urging member 2150 is removed, the elastic force generated by the fifth elastic member 2109 is released, which may drive the coupling member 2108 to reset and move from the extended position to the retracted position. That is, the fifth elastic member 2109 may also be used to reset the moved coupling member 2108 to avoid the problem that when the process cartridge 2100 is disassembled from the image forming device 1, disassembly interference with the image forming device occurs so that the developing cartridge cannot be disassembled. The column 2108a of the coupling member 2108 passes through the hollow parts of the second urged member 2144 and the first urged member 2140 and is mounted on the photosensitive drum 2103. The coupling member 2108 is arranged so that the driven protrusion 2114 of the coupling member 2108 is located at the right end of the second urged member 2144, and a part of the coupling member 2108 abuts against the second urged member 2144. When the second urged member 2144 moves rightward, the second urged member 2144 may push the coupling member 2108 to move from the retracted position to the extended position from left to right under the action of overcoming the elastic force of the fifth elastic member 2109. That is, the coupling member 2108 may move rightward in response to the movement of the second urged member 2144, that is, the coupling member 2108 may move rightward in response to the movement of the urging member 2150. The engaging surface of the coupling member 2108 in this embodiment is also configured to be substantially parallel to the left-right direction, which is substantially the same as the engaging surface in Embodiment 19, and will not be described in detail here.

During the rightward movement of the coupling member 2108 from the retracted position to the extended position, the coupling member 2108 may push the driving force applying member 10 to move rightward from the extended position to the retracted position under the action of overcoming the elastic force of the elastic member connected thereto, and maintain the driving force applying member 10 in the retracted position during the coupling and rotation of the two. The two maintain elastic contact, which improves the coupling stability of the two and can avoid separation from each other during the rotation. Moreover, the coupling member 2108 includes the abutment surface 2115 described in the aforementioned embodiment, and the distance between the abutment surface 2115 and the right side surface 2108b of the coupling member 2108 is P, where 2 mm≤P≤5 mm. In the case of P being in this range, when the process cartridge 2100 is mounted in the image forming device 1, the abutment surface 2115 may abut against a claw portion of the free end of the force bearing member and urge the force bearing member to retract rightward, so that the force bearing member is axially disengaged from the connecting shaft 40, and the two may rotate relative to each other. The abutment surface 2115 may further push the second protrusion 40b at the left end of the connecting shaft 40 to axially disengage from the third protrusion 10a engaged therewith on the driving force applying member 10. That is, when the driving force applying member 10 rotates, the driving force applying member 10 cannot drive the connecting shaft 40 to rotate. The connecting shaft 40 is unable to drive the damper 44 to rotate, and the coupling member 2108 and the photosensitive drum 2103 connected to the coupling member 2108 will no longer receive the damping output from the image forming device 1, thereby eliminating the abnormal noise caused by the frequent engagement and disengagement between the second protrusion 40b and the third protrusion 10a.

Further, a telescopic stroke of the coupling member 2108 is defined as L, and the telescopic stroke is the distance between the coupling member 2108 when it is in the retracted position and the coupling member 2108 when it is in the maximum extended position. In this embodiment, the maximum telescopic stroke L of the coupling member 2108 is 12 mm. However, to ensure the coupling stability between the coupling member 2108 and the driving force applying member 10, further, the minimum telescopic stroke L of the coupling member 1908 is 2 mm. That is, 2 mm≤L≤12 mm.

To further improve the printing quality of the process cartridge 2100, the process cartridge 2100 further includes ninth elastic members 2180 connected between the developing cartridge supporting the developing roller and the drum cartridge supporting the photosensitive drum 2103. The ninth elastic members 2180 are arranged at the left and right ends of the process cartridge 2100, respectively, to ensure the uniformity of the developer conveyed to the left and right sides of the photosensitive drum 2103. Preferably, the ninth elastic member 2180 is a tension spring or a compression spring, which has the advantages of low cost, stable performance, etc. In the process cartridge 2100, an elastic force generated by the ninth elastic member 2180 is applied to the developing cartridge and the drum cartridge, and is configured to maintain the developing roller and the photosensitive drum 2103 close to each other, so that the developing roller and the photosensitive drum 2103 maintain close contact, and the effect of the developer conveyed to the photosensitive drum 2103 by the developing roller is improved.

Next, the specific action process of the coupling member 2108 during the installation and disassembly of the process cartridge 2100 will be described. First, the process cartridge 2100 is mounted in the image forming device 1 with the coupling member 2108 in the retracted position. At this time, the coupling member 2108 and the driving force applying member 10 face each other in the left-right direction and are spaced apart by a certain distance. After the door cover 4 of the image forming device 1 is closed, on the one hand, the driving force applying member 10 extends and moves in a direction close to the first coupling member 1910; on the other hand, the force receiving portion 2150a of the urging member 2150 of the process cartridge 2100 receives the pressing force from the second pressing portion 5b in the image forming device 1, which will force the urging member 2150 to move from the first position to the second position from top to bottom under the action of overcoming the elastic force of the sixth elastic member 2151. Almost at the same time, the urging portion 2150b located at the lower end of the urging member 2150 urges the first urged portion 2140a of the first urged member 2140, and the first urged member 2140 rotates in response to the movement of the urging member 2150. Subsequently, the spiral protrusion 2140b of the first urged member 2140 urges the spiral groove 2144a of the second urged member 2144, which will generate a rightward urging force. The urging force will force the second urged member 2144 to move from left to right, and then the second urged member 2144 will push the coupling member 2108 to overcome the elastic force of the fifth elastic member 2109 and move from the retracted position to the extended position from left to right. The coupling member 2108 is in the extended position and gradually urges the driving force applying member 10 to retract, so that the coupling member 2108 and the driving force applying member 10 maintain elastic contact and coupling. Therefore, the coupling member 2108 may stably receive the rotational driving force of the driving force applying member 10, and at this time, the abutment surface 2115 of the coupling member 2108 may further urge the force bearing member to retract, so that the force bearing member and the connecting shaft 40 are axially disengaged from each other, and the two may rotate relative to each other. As the force bearing member further retracts, the force bearing member pushes the connecting shaft 40 to retract together, until a second protrusion 40b at the right end of the connecting shaft 40 is axially disengaged from a third protrusion 10a of the driving force applying member 10 matched therewith. At this time, the driving force applying member 10 does not directly drive the connecting shaft 40 to rotate through the protrusion. Even if the force bearing member is subsequently driven to rotate by the coupling member 2108, the force bearing member and the connecting shaft 40 have previously completed axial disengagement. Therefore, the connecting shaft 40 still will not rotate, so that the damper 44 cannot be driven to rotate, and finally, the coupling member 2108 and the photosensitive drum 2103 connected thereto will not receive the damping in the image forming device 1. The specific action of the coupling member 2110 when the process cartridge 2100 is disassembled from the image forming device 1 is substantially opposite to the action of the first coupling member when the process cartridge 2100 is mounted to the image forming device 1, and will not be described in detail here.

### Embodiment 11

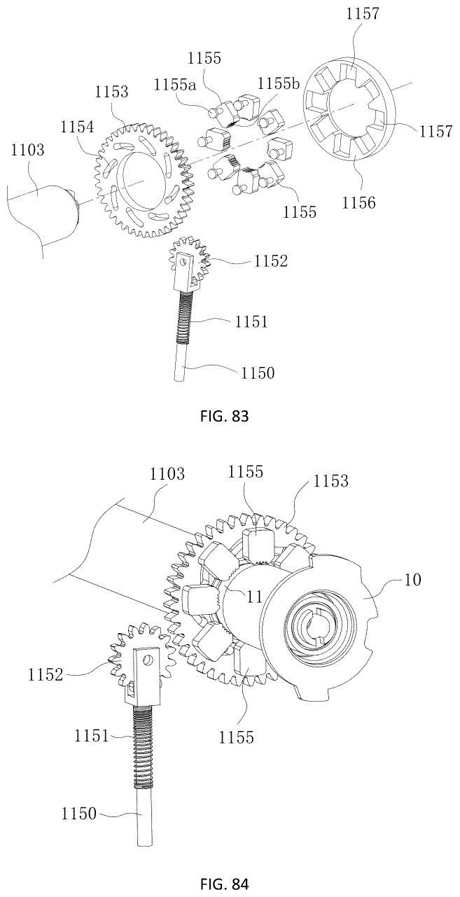

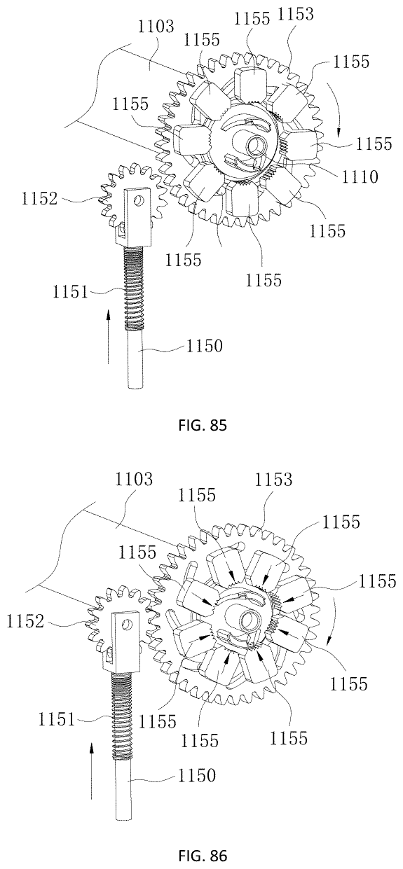

Next, Embodiment 11 of the present disclosure will be described in detail with reference to FIGS. 82-86. This embodiment shows a process cartridge. The parts of the process cartridge that are the same as those in the above embodiments will not be described in detail here. The difference is that the structure of the process cartridge 1100 for receiving the driving force is different.

The process cartridge further includes a drum frame 1102 and an urging member arranged at the right end of the drum frame 1102 and movable relative to the drum frame 1102. The urging member includes a first urging member 1150 that may be moved by receiving an external pressing force, and a second urging member 1152 that is connected to the first urging member 1150 and may move with the first urging member 1150. Preferably, the first urging member 1150 is a rod, and the second urging member 1151 is a rotatable gear. A sixth elastic member 1151 is connected to the first urging member 1151, and the sixth elastic member 1151 may be used to, when the first urging member 1150 is not pressed, reset the first urging member 1150 and the second urging member 1152 connected to the first urging member 1150 to a position that allows them to be pressed by the external force next time. The process cartridge further includes an urged member 1153 coaxially arranged with the first coupling member 1110. The urged member 1153 is rotatably arranged at the right end of the drum frame 1102 and is adjacent to the first coupling member 1110. Preferably, the urged member 1153 is a gear, which may be urged by the second urging member 1152 to rotate. A plurality of second guide portions 1154 are arranged on the urged member 1153, and the plurality of second guide portions 1154 are arranged at intervals along the circumferential direction of the urged member 1153. Preferably, the second guide portion 1154 is an arc-shaped track groove penetrating the urged member 1153 along the thickness direction of the urged member 1153, and at least a part of the second guide portion 1154 extends in a radial direction of the urged member 1153 (i.e., a direction perpendicular to the rotation axis of the first coupling member 1110). When viewed from the right end of the urged member 1153, along the clockwise rotation direction of the urged member 1153, the second guide portion 1154 extends in a radial direction toward a direction gradually away from the rotation axis of the first coupling member 1110. That is, in the radial direction, the second guide portion 1154 has a first end away from the rotation axis of the first coupling member 1110 and a second end closer to the rotation axis of the first coupling member 1110 than the first end. The process cartridge further includes a plurality of pressure applying members 1155. The pressure applying member 1155 includes a guided portion 1155a that may be guided by the second guide portion 1154, and the guided portion 1155a may be driven by the urged member 1153 to move in the second guide portion 1154. The pressure applying member 1155 further includes a pressure applying portion 1155b that may move with the guided portion 1155a. Before the second urging member 1152 urges the urged member 1153, the pressure applying member 1155 is located at the first end of the second guide portion 1154 and is in a first position. At this time, the pressure applying portion 1155b of the pressure applying member 1155 is spaced apart from the outer peripheral surface of the driving force pressing member 10. After the second urging member 1152 urges the urged member 1153, the pressure applying member 1155 can move from the first position to a second position along the second guide portion 1154 in response to the movement of the urged member 1153. At this case, the pressure applying member 1155 in the second position is closer to the rotation axis of the first coupling member 1110 than the pressure applying member 1155 in the first position. The pressure applying portion 1155b of the pressure applying member 1155 comes into contact with the outer peripheral surface of the driving force applying member 10 and may apply pressure to the outer peripheral surface of the driving force applying member 10, which makes the coupling between the first coupling member 1110 and the driving force applying member 10 tighter, and can prevent the first coupling member 1110 and the driving force applying member 10 from moving in the left-right direction and thus affecting the coupling stability of the two. Preferably, three pressure applying members 1155 are provided, and the three pressure applying members 1155 are arranged on the urged member 1153 at equal intervals in the circumferential direction of the urged member 1153. The pressure applying members 1155 can apply sufficient pressure to the driving force applying member 10 to ensure that the two have sufficient friction, thereby ensuring the coupling stability of the first coupling member 1110 and the driving force applying member 10 in the left-right direction. Also, the structure of the process cartridge is simplified by reducing the number of pressure applying members 1155. In this embodiment, the pressure applying member 1155 may also be referred to as a connecting member, and the pressure applying portion 1155b may also be referred to as a connecting portion. When the process cartridge needs to be taken out of the image forming device 1, the pressing force applied to the first urging member 1150 is removed, and the first urging member 1150 is reset by the elastic force of the sixth elastic member 1151 arranged thereon, and drives the second urging member 1152 to move downward together. At this time, the urged member 1153 rotates reversely and drives the pressure applying member 1155 to move from the second position to the first position to ensure that the first coupling member 1110 and the driving force applying member 10 are loosened and can be separated from each other, thereby ensuring that the process cartridge can be smoothly taken out of the image forming device 1, and also ensuring that the pressure applying member can apply pressure to the driving force applying member 10 again when the process cartridge is mounted next time. Preferably, the pressure applying portion 1155b of the pressure applying member 1155 is made of an elastic material such as rubber, silicone or even a spring. After being squeezed and deformed, the elastic material may apply a generated elastic force to the outer peripheral surface of the driving force applying member 10, so that the contact area between the two will be increased and the connection stability will be effectively improved. Meanwhile, radial interference between the two during the contact process can also be avoided. Of course, the pressure applying portion may also be made of plastic material, which is not a limitation. Optionally, the urging member and the urged member in this embodiment may not be limited to the gear structure, and in some other embodiments, they may also be a structure in which a friction wheel urges a friction wheel or rods cooperate with each other. Further, to enable the pressure applying member 1155 to be stably supported and positioned when the pressure applying member 1155 is stationary or moving, the process cartridge includes a substantially disc-shaped support member 1156. A plurality of support portions 1157 for accommodating at least a part of the pressure applying member 1155 in a matching manner are arranged at intervals in the circumferential direction of the support member 1156, and the support portion 1157 is a groove formed on the support member 1156, so that the pressure applying member 1155 can be stably supported and positioned.

In general, the pressure applying member 1155 is provided in this embodiment, and when the first coupling member 1110 and the driving force applying member 10 are coupled, the pressure applying member 1155 may apply pressure to the outer peripheral surface of the driving force applying member 10, so as to hold the driving force applying member 10 tightly, thereby addressing the technical problem of preventing the first coupling member 1110 and the driving force applying member 10 from moving left and right, and improving the coupling stability between the two. Optionally, the first coupling member 1110 in this embodiment may also not be provided with a driven protrusion, and directly rely on the friction force between the pressure applying member 1155 and the driving force applying member 10 to drive the first coupling member 1110 and the photosensitive drum connected to the first coupling member 1110.

In the process cartridge provided by the present disclosure, on the premise of ensuring that the first coupling member is stably engaged with the driving force applying member and the braking force applying member of the image forming device, in a first aspect, by reducing the inclined surface structure in the first coupling member, the structure of the first coupling member is simplified and the yield rate is improved; in a second aspect, by providing the groove structure on the second protrusion of the first coupling member, the material usage is reduced and the production cost is reduced; in a third aspect, the first coupling member adopts a retractable structure, which can improve the coupling stability of the first coupling member and the driving unit; in a fourth aspect, by providing an abutment surface, the braking force applying member can be pushed to retract, so that the first coupling member can work normally without receiving the braking force of the image forming device, which can effectively remove the redundant design of the image forming device and simplify the structure of the image forming device.

What is claimed is:

1. A process cartridge, comprising:
a frame;
a photosensitive drum rotatably supported on the frame and being rotatable about a photosensitive drum rotation axis extending in a first direction;
a first coupling member connected to a first end of the photosensitive drum in the first direction, wherein the first coupling member is capable of receiving an external force and driving the photosensitive drum to rotate; the first coupling member comprises a first protruding portion, and the first protruding portion comprises:
a first surface extending in a direction away from the photosensitive drum in a first direction;
a second surface located on a downstream side of the first surface in a rotation direction of the first coupling member, the second surface extending in a direction away from the photosensitive drum and arranged obliquely relative to the first direction; and
a third surface, wherein a distance from the first end of the photosensitive drum to the third surface when measured in the first direction decreases along the extension of the third surface in the rotation direction of the first coupling member;
wherein in the rotation direction of the first coupling member, a starting position of the extension of the third surface is flush with the first surface or located on the downstream side of the first surface.

2. The process cartridge according to claim 1, wherein an ending position of the extension of the third surface is adjacent to the second surface in the rotation direction of the first coupling member.

3. The process cartridge according to claim 1, wherein the first coupling member further comprises a second protruding portion; the second protruding portion comprises a protruding portion surface extending in the rotation direction of the first coupling member and facing away from the photosensitive drum in the first direction; and in the rotation direction of the first coupling member, the protruding portion surface is arranged on an upstream side of the third surface and spaced apart from the third surface.

4. The process cartridge according to claim 3, wherein a downstream end of the protruding portion surface in the rotation direction of the first coupling member has a first distance point; when measured in a direction perpendicular to the first direction, the first distance point is the farthest point on the protruding portion surface from the rotation axis of the first coupling member; and after projection in the first direction, a first line segment connecting the first distance point and a point located at an upstream end of the third surface in the rotation direction of the first coupling member is made, and the shortest length of the first line segment is K, where 0 mm<K<4 mm.

5. The process cartridge according to claim 3, wherein in the first direction, a downstream end of the protruding portion surface in the rotation direction of the first coupling member is flush with an upstream end of the third surface in the rotation direction of the first coupling member, or is further away from the photosensitive drum than the upstream end of the third surface in the rotation direction of the first coupling member.

6. The process cartridge according to claim 3, wherein the protruding portion surface comprises a fourth surface and a fifth surface arranged adjacent to each other; the fourth surface is arranged on an upstream side of the fifth surface in the rotation direction of the first coupling member; a distance from the first end of the photosensitive drum to the fourth surface when measured in the first direction increases along the extension of the fourth surface in the rotation direction of the first coupling member; and the fifth surface is configured as a plane perpendicular to the first direction.

7. The process cartridge according to claim 6, wherein the first coupling member further comprises a shield surface extending about the rotation axis of the first coupling member, the shield surface and the fourth surface have an overlapping portion when projected along the first direction, and the shield surface is flush with the fifth surface in the first direction.

8. The process cartridge according to claim 1, wherein the first coupling member further comprises a second protruding portion located on an upstream side of the first protruding portion in the rotation direction of the first coupling member; the second protruding portion comprises a protruding portion surface extending in the rotation direction of the first coupling member and facing away from the photosensitive drum in the first direction; and the first coupling member further comprises a groove formed on the second protruding portion, and the groove is arranged at a position closer to the photosensitive drum than the protruding portion surface in the first direction.

9. The process cartridge according to claim 1, wherein the first coupling member further comprises a fourth surface arranged on the downstream side of the second surface in the rotation direction of the first coupling member; a distance from the first end of the photosensitive drum to the fourth surface when measured in the first direction increases along the extension of the fourth surface in the rotation direction of the first coupling member; and a second line segment perpendicular to the first direction and connecting the third surface and the fourth surface is made, and the shortest distance of the second line segment is M, where 1 mm<M<4 mm.

10. The process cartridge according to claim 9, wherein 2 mm<M<3 mm.

11. The process cartridge according to claim 1, wherein an upstream end of the third surface in the rotation direction of the first coupling member has a first point; a downstream end of the third surface in the rotation direction of the first coupling member has a second point; when measured in a direction perpendicular to the first direction, the first point and the second point are both points on the third surface that are farthest from the rotation axis of the first coupling member; and a third line segment connecting the first point and the second point is made, and a length of the third line segment is W, where 3 mm<W<4 mm.
